(19) United States
(12) Patent Application Publication
(10) Pub. No.: US 2026/0030518 A1
(43) Pub. Date: Jan. 29, 2026

(54) COHERENT HYPEREDGES FOR DOCUMENT QUESTION ANSWERING

(71) Applicant: International Business Machines Corporation, Armonk, NY (US)

(72) Inventors: Lokesh Mishra, Bern (CH); Gerhard Ingmar Meijer, Zuerich (CH); Peter Willem Jan Staar, Zurich (CH); Michele Dolfi, Zurich (CH)

(21) Appl. No.: 18/787,045

(22) Filed: Jul. 29, 2024

(51) Int. Cl. G06N 5/02; G06N 5/04

(52) U.S. Cl. CPC G06N 5/02; G06N 5/04

(57) ABSTRACT

Systems or techniques that facilitate coherent hyperedges for document QA are provided. In various embodiments, a system can generate, via a foundation model, a hypergraph comprising nodes and hyperedges, wherein the nodes represent entities in an information source, wherein the hyperedges represent relationships between two or more of the nodes, and wherein the hyperedges are associated with respective probabilistic weights. In various cases, the system can further select, from the hyperedges, a set of coherent hyperedges for a natural language question that represents coherent information from the information source.

### BACKGROUND

The subject disclosure relates generally to document question answering (QA), and more specifically to coherent hyperedges for document QA.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate coherent hyperedges for document question answering (QA) are described.

According to one or more embodiments, a system is provided. The system can comprise a non-transitory computer-readable memory that can store computer-executable components. The system can further comprise a processor that can be operably coupled to the non-transitory computer-readable memory and that can execute at least one of the computer executable components that can generate, via a foundation model, a hypergraph comprising nodes and hyperedges, wherein the nodes represent entities in an information source, wherein the hyperedges represent relationships between two or more of the nodes, and wherein the hyperedges are associated with respective probabilistic weights. In various aspects, the at least one of the computer executable components can further select, from the hyperedges, a set of coherent hyperedges for a natural language question that represents coherent information from the information source.

According to one or more embodiments, a computer-implemented method is provided. In various embodiments, the computer-implemented method can comprise generating, by a system operatively coupled to a processor and via a foundation model, a hypergraph comprising nodes and hyperedges, wherein the nodes represent the entities, wherein the hyperedges represent relationships between two or more of the nodes, and wherein the hyperedges are associated with respective probabilistic weights. In various aspects, the computer-implemented method can comprise selecting, by the system and from the hyperedges, a set of coherent hyperedges for a natural language question that represents coherent information from the information source.

According to one or more embodiments, a computer program product for facilitating coherent hyperedges for document QA is provided. In various embodiments, the computer program product can comprise a non-transitory computer-readable memory having program instructions embodied therewith. In various aspects, the program instructions can be executable by a processor to cause the processor to generate, by the processor and via a foundation model, wherein the nodes represent the entities, wherein the hyperedges represent relationships between two or more of the nodes, and wherein the hyperedges are associated with respective probabilistic weights. In various aspects, the program instructions can be further executable by the processor to cause the processor to select, by the processor and from the hyperedges, a set of coherent hyperedges for a natural language question that represents coherent information from the information source.

### DESCRIPTION OF THE DRAWINGS

One or more embodiments are described below in the Detailed Description section with reference to the following drawings:

FIG. 1 illustrates a block diagram of an example, non-limiting system that facilitates coherent hyperedges for document QA in accordance with one or more embodiments described herein.

FIG. 2 illustrates a block diagram of an example, non-limiting system including a knowledge graph, a hypergraph, a foundation model, and a database that facilitates coherent hyperedges for document QA in accordance with one or more embodiments described herein.

FIG. 3 illustrates an example, non-limiting block diagram of extracting entities from an information source in accordance with one or more embodiments described herein.

FIG. 4 illustrates an example, non-limiting block diagram of a knowledge graph in accordance with one or more embodiments described herein.

FIG. 5 illustrates an example, non-limiting block diagram of a hypergraph in accordance with one or more embodiments described herein.

FIG. 6 illustrates an example, non-limiting block diagram of generating a hypergraph via a foundation model in accordance with one or more embodiments described herein.

FIG. 7 illustrates a block diagram of an example, non-limiting system including a query component, an embedding component, and an embedding model that facilitates coherent hyperedges for document QA in accordance with one or more embodiments described herein.

FIG. 8 illustrates an example, non-limiting block diagram of generating embeddings in accordance with one or more embodiments described herein.

FIG. 9 illustrates an example, non-limiting block diagram of generating coherent hyperedges in accordance with one or more embodiments described herein.

FIG. 10 illustrates a block diagram of an example, non-limiting system including a generative large language model and a natural language answer that facilitates coherent hyperedges for document QA in accordance with one or more embodiments described herein.

FIG. 11 illustrates an example, non-limiting block diagram showing how a natural language answer can be generated based on a natural language query and set of coherent hyperedges in accordance with one or more embodiments described herein.

FIG. 12 illustrates an example, non-limiting diagram that facilitates coherent hyperedges for document QA in accordance with one or more embodiments described herein.

FIG. 13 illustrates an example, non-limiting diagram that facilitates coherent hyperedges for document QA in accordance with one or more embodiments described herein.

FIG. 14 illustrates an example, non-limiting diagram that facilitates coherent hyperedges for document QA in accordance with one or more embodiments described herein.

FIGS. 15-16 illustrate example, non-limiting information sources in accordance with one or more embodiments described herein.

FIG. 17 illustrates an example, non-limiting diagram of generating a hypergraph from an information source in accordance with one or more embodiments described herein.

FIG. 18 illustrates an example, non-limiting diagram of a user chat bot in accordance with one or more embodiments described herein.

FIG. 19 illustrates a block diagram of an example, non-limiting system including a training component that facilitates coherent hyperedges for document QA in accordance with one or more embodiments described herein.

FIG. 20 illustrates an example, non-limiting block diagram showing how foundation models can be trained in accordance with one or more embodiments described herein.

FIGS. 21-22 illustrate a flow diagram of an example, non-limiting computer-implemented method that facilitates coherent hyperedges for document QA in accordance with one or more embodiments described herein.

FIG. 23 illustrates a block diagram of an example, non-limiting operating environment in which one or more embodiments described herein can be facilitated.

### DETAILED DESCRIPTION

According to one or more embodiments, a system is provided. The system can comprise a non-transitory computer-readable memory that can store computer-executable components. The system can further comprise a processor that can be operably coupled to the non-transitory computer-readable memory and that can execute at least one of the computer executable components that can generate, via a foundation model, a hypergraph comprising nodes and hyperedges, wherein the nodes represent entities in an information source, wherein the hyperedges represent relationships between two or more of the nodes, and wherein the hyperedges are associated with respective probabilistic weights. In various aspects, the at least one of the computer executable components can further select, from the hyperedges, a set of coherent hyperedges for a natural language question that represents coherent information from the information source. Such embodiments can provide the advantages of improving coherence of document question-answering, and enabling document question-answering for long documents or a plurality of documents.

In one or more embodiments of the aforementioned system, generating the hypergraph can comprise: extracting the entities from the information source; generating a knowledge graph comprising the nodes and edges, wherein the nodes represent the entities, wherein the edges are pair-wise relationships between the nodes, and wherein the edges are associated with respective probabilistic weights; and generating, based on the respective probabilistic weights of the edges, the hypergraph using the knowledge graph. Such embodiments can provide the advantage of reducing hallucinations in large language models for document question-answering.

In one or more embodiments of the aforementioned system, the at least one of the computer executable components can further embed, via a text-embedding model, the hyperedges and the natural language question. Such embodiments can provide the advantage of reducing hallucinations in large language models for document question-answering.

In one or more embodiments of the aforementioned system, the at least one of the computer executable components can further select, using semantic search, the set of coherent hyperedges based on a similarity between the natural language question and the hyperedges. Such embodiments can provide the advantage of improving coherence of document question-answering.

In one or more embodiments of the aforementioned system, the at least one of the computer executable components can further input the natural language question and the set of coherent hyperedges into a generative large language model to generate a natural language response. Such embodiments can provide the advantage of enabling document question-answering for long documents or a plurality of documents

In one or more embodiments of the aforementioned system, the probabilistic weights associated with the hyperedges can be a function of proximity between at least one of: location of the entities, length of information source, or thematic entity category. Such embodiments can provide the advantage of improving coherence of document question-answering.

In one or more embodiments of the aforementioned system, the probabilistic weights associated with the hyperedges can quantify a probability of coherently linking two or more of the nodes with a hyperedge. Such embodiments can provide the advantage of improving coherence of document question-answering.

In one or more embodiments of the aforementioned system, the probabilistic weights associated with the edges can quantify a probability of nodes being coherently related. Such embodiments can provide the advantage of improving coherence of document question-answering.

In one or more embodiments of the aforementioned system, the entities can comprise entities extracted from the information source using natural language processing or user-identified entities. Such embodiments can provide the advantage of reducing hallucinations in large language models for document question-answering.

In one or more embodiments of the aforementioned system, the hyperedges can be stored in a database, where selecting the set of coherent hyperedges comprises retrieving the set of coherent hyperedges from the database in response to receiving the natural language question. Such embodiments can provide the advantage of improving processing efficiency of document question-answering.

In one or more embodiments of the aforementioned system, training the foundation model can comprise: pre-training the foundation model on a first training dataset to generate natural language, wherein the first training dataset comprises a plurality of textual data; and training the foundation model on a second training dataset to generate the hypergraph, wherein the second training dataset comprises textual data and corresponding hypergraphs. Such embodiments can provide the advantage of reducing hallucinations in large language models for document question-answering.

The aforementioned system can further be implemented as a computer-implemented method or a computer program product.

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Document question-answering (QA) is a subfield of natural language processing (NLP) that focuses on developing systems capable of answering questions based on the content of an information source, such as a document. Document QA systems work with unstructured or semi-structured text, such as articles, reports, or manuals. Such systems leverage advanced NLP techniques to understand the context and extract relevant information.

Various existing techniques for performing document QA comprise using NLP techniques such as named entity recognition (NER) with use of large language models (LLMs) to generate answers to natural language questions. Furthermore, existing techniques for performing document QA can comprise generating knowledge graphs to determine answers based on structured data.

Unfortunately, such existing techniques are prone to producing incoherent answers and thus cannot be reliably implemented for document QA. For example, LLMs for document QA are prone to hallucinations (e.g., instances where a machine learning model, particularly in natural language processing, generates information or details that are plausible-sounding but factually incorrect or nonsensical). Even after extensive training, which can be effort-intensive and time-consuming, the LLMs can be unable to accurately and coherently generate knowledge graphs that represent the information sources.

Furthermore, such existing techniques are unable to accurately perform long document QA. A long document is a piece of text that spans multiple pages or consists of a substantial number of words, often exceeding several thousand (e.g., research papers, legal contracts, technical manuals, books, or lengthy reports). That is, the context windows in LLMs can be insufficient to enable accurate and coherent long document QA.

Even further, extracting coherent information for such existing techniques can prove difficult. In particular, NER can allow extraction of entities form an information source, however, only simple binary relationships can be extracted (e.g., relationships between only two entities). Therefore, coherent information in relationships between multiple entities is not extracted, hindering the coherence of entity extraction for document QA.

Various embodiments of the present disclosure can be implemented to produce a solution to these problems. Embodiments described herein include systems, computer-implemented methods, and computer program products that can enable document QA via coherent hyperedges.

In various embodiments described herein, there can be an information source. Furthermore, in various embodiments, a graph component can generate hypergraph via foundation model. The hypergraph can comprise nodes and hyperedges. The nodes of the hypergraph can represent entities from the information source. The hyperedges of the hypergraph can represent relationships between two or more nodes. In various aspects, training of the foundation model can comprise training the foundation model on a training dataset to generate the hypergraph, wherein the training dataset comprises textual data and corresponding hypergraphs. Moreover, the hyperedges can be associated with respective probabilistic weights that quantify a probability of coherently linking two or more of the nodes with a hyperedge. In various embodiments, a natural language question can be received, and a selection component can select, from the hyperedges, a set of coherent hyperedges for the natural language question that represents coherent information from the information source. In various aspects, a generative LLM can receive the natural language question and the set of coherent hyperedges as input and generate a natural language answer as output. Further, the selection component can select a subset of the set of coherent hyperedges that are relevant to the natural language question. In some instance, semantic search can be employed to determine which hyperedges of the set of coherent hyperedges are relevant to the natural language question.

Various embodiments described herein can be considered as being advantageous over existing techniques. Indeed, the generative LLM with coherent hyperedges can exhibit higher coherence of information. In other words, a generative LLM can have a higher propensity for accurately or reliably performing document QA on inputted texts. Moreover, construction of a hypergraph via a foundation model can enable document QA over long documents or multiple information sources. Therefore, various embodiments described herein can be considered as a more coherent and accurate way of performing document QA, as compared to existing techniques.

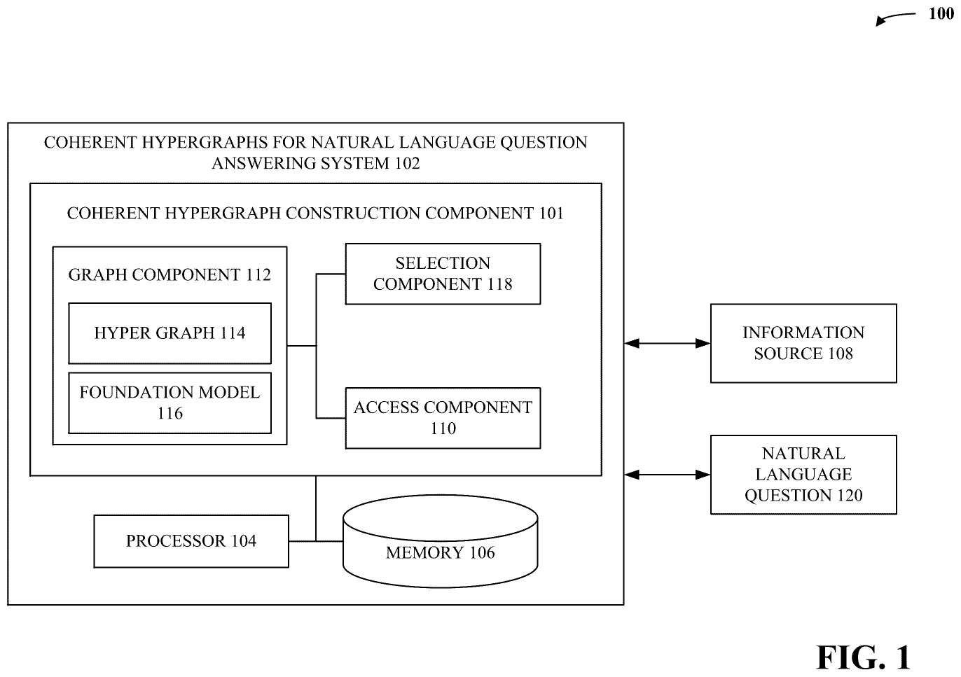

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 2500 illustrated at FIG. 25. For example, non-limiting system 100 can be associated with, such as accessible via, a computing environment 2500 described below with reference to FIG. 25, such that aspects of processing can be distributed between non-limiting system 100 and the computing environment 2500. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that facilitates coherent hyperedges for document QA in accordance with one or more embodiments described herein. Non-limiting system 100 can comprise processor 104, memory 106, coherent hypergraph construction component 101, access component 110, graph component 112, graph component 112, and/or selection component 118.

Non-limiting system 100 and/or the components of non-limiting system 100 can be employed to use hardware and/or software to solve problems that are highly technical in nature (e.g., related to document QA, natural language processing, generative language models, etc.), that are not abstract and that cannot be performed as a set of mental acts by a human. Further, some of the processes performed may be performed by specialized computers for carrying out defined tasks related to the document QA. Non-limiting system 100 and/or components of the system can be employed to solve new problems that arise through advancements in technologies mentioned above, computer architecture, and/or the like. Non-limiting system 100 can provide technical improvements to document QA by improving processing efficiency for long document QA, improving performance of large language models for QA, and/or improving coherence of machine learning models, etc.

Discussion turns briefly to processor 104 and memory 106 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., coherent hypergraph construction component 101, access component 110, graph component 112, graph component 112, and/or selection component 118) to perform one or more actions. In one or more embodiments, memory 106 can store computer-executable components (e.g., coherent hypergraph construction component 101, access component 110, graph component 112, graph component 112, and/or selection component 118).

In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to processor 104 and/or memory 106 described above, non-limiting system 100 can comprise one or more computer and/or machine readable, writable and/or executable components and/or instructions that, when executed by processor 104, can enable performance of one or more operations defined by such component(s) and/or instruction(s).

In various embodiments, there can be an information source 108. In various cases, the information source 108 can comprise any suitable size (e.g., any suitable number of pages, sections, paragraphs, portions, etc.). In various aspects, the information source 108 can be any suitable electronic data (e.g., one or more scalars, one or more vectors, one or more matrices, one or more tensors, one or more character strings, or any suitable combination thereof). In some aspects, any of the information source 108 can be any suitable electronic data or file. In various aspects, the information source 108 can textually, numerically, or graphically indicate, specify, convey, describe, explain, show, or otherwise represent: any suitable information (e.g., can comprise textual data, can graphically show figures or drawings, can comprise data tables, can comprise metadata).

As a non-limiting example, the information source 108 can be a service manual or handbook (or any paragraph, page, chapter, or other portion thereof). As another non-limiting example, the information source 108 can be an excerpt of a textbook (or any paragraph, page, section, or other portion thereof). As still another non-limiting example, the information source 108 can be a cost analysis report (or any paragraph, page, section, or other portion thereof). As even another non-limiting example, the information source 108 can be a technical paper (or any page, section, or portion thereof). As yet another non-limiting example, the information source 108 can be a webpage (or any paragraph, page, section, or other portion thereof). As still another non-limiting example, the information source 108 can be different sections (or any paragraph, page, chapter, or other portion thereof) of a document.

In various instances, any of the information source 108 can be written or otherwise created via any suitable word processing software (e.g., Microsoft Word®), or via any suitable quantitative analysis software (e.g., Microsoft Excel®).

In any case, it can be desired to generate a hypergraph 114 to coherently represent the information source 108, so that questions regarding the information source 108 can be automatically and coherently answered via hypergraph querying techniques. As described herein, the coherent hypergraphs for natural language question answering system 102 can facilitate or accomplish such objectives.

In various embodiments, the coherent hypergraphs for natural language question answering system 102 can comprise coherent hypergraph construction component 101. In various aspects, the coherent hypergraph construction component 101 can comprise sub-components (e.g., access component 110, graph component 112, selection component 118).

In various embodiments, the coherent hypergraph construction component 101 can comprise an access component 110. In various aspects, the access component 110 can electronically access the information source 108. As a non-limiting example, the access component 110 can electronically retrieve or otherwise electronically obtain the information source 108 from any suitable centralized or decentralized data structures (not shown) or from any suitable centralized or decentralized computing devices (not shown). In any case, the access component 110 can electronically access the information source 108, such that the access component 110 can serve as a conduit through which other components of the coherent hypergraphs for natural language question answering system 102 can electronically interact with the information source 108. In various embodiments, the access component 110 can electronically access a natural language question 120.

In various embodiments, the coherent hypergraph construction component 101 can comprise can comprise a graph component 112. In various aspects, as described herein, the graph component 112 can generate hypergraph 114 via foundation model 116. In various aspects, the graph component 112 can electronically store, electronically maintain, electronically control, or otherwise electronically access the hypergraph 114. The hypergraph 114 can comprise nodes and hyperedges. The nodes of hypergraph 114 can represent entities from information source 108. The hyperedges of hypergraph 114 can represent relationships between the nodes (e.g., can represent relationships between the entities from information source 108). In particular, the hyperedges can represent relationships between two or more nodes of hypergraph 114. In various cases, the hypergraph 114 can be any suitable graph data structure having nodes and hyperedges, which can represent whatever information is described or conveyed by the information source 108.

An advantage of such embodiments allows linking of more than two entities from an information source, as opposed to binary relationships between only two entities.

In various embodiments, the graph component 112 can electronically store, electronically maintain, electronically control, or otherwise electronically access the foundation model 116. In various instances, the foundation model 116 can have or otherwise exhibit any suitable deep learning internal architecture. For instance, the foundation model 116 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be transformer layers, whose learnable or trainable parameters can be input-state weight matrices or hidden-state weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

Regardless of the specific internal architecture (e.g., the specific number, types, or organization of layers) implemented within the foundation model 116, the foundation model 116 can be configured for natural language processing and hypergraph generation. In other words, the foundation model 116 can be configured to receive information source 108 (which can be accompanied by any suitable numerical or graphical data) as input and to generate hypergraph 114, where such hypergraph 114 represents information from information source 108 (e.g., represents entities and relationships between such entities from information source 108). Furthermore, the foundation model 116 can be configured to determine respective probabilistic weights associated with the hyperedges. More specifically, the hyperedges are associated with respective probabilistic weights that quantify a probability of coherently linking two or more of the nodes with a hyperedge. In other words, the respective probabilistic weights define a probability that the nodes in the hyperedge are coherently related.

In various embodiments, the coherent hypergraph construction component 101 can comprise a selection component 118. In various aspects, as described herein, the selection component 118 can select, from the hyperedges, a set of coherent hyperedges for the natural language question 120 that represents coherent information from the information source 108.

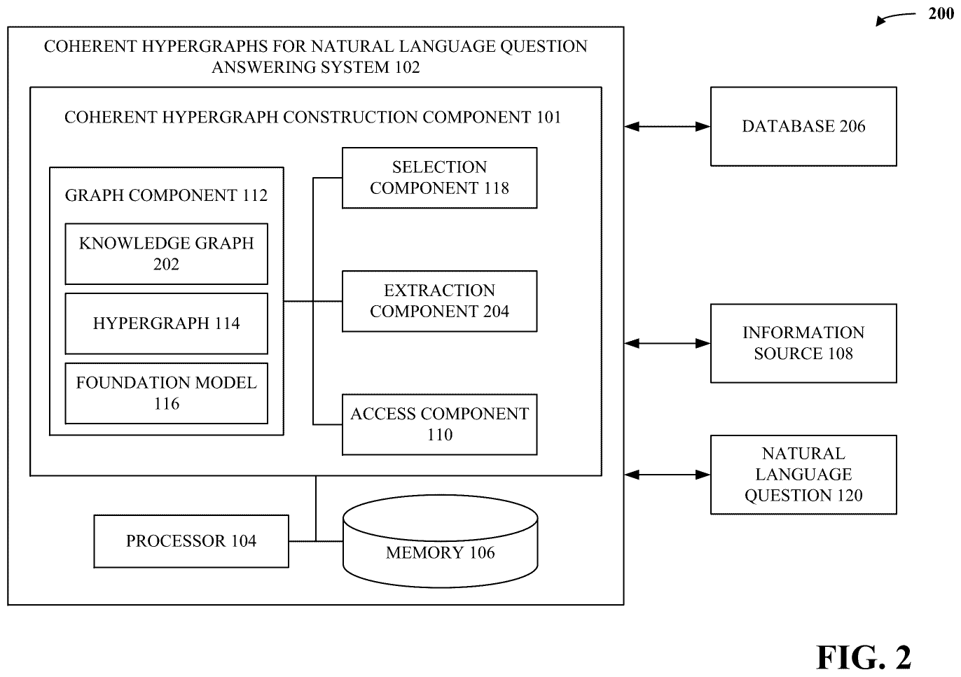

FIG. 2 illustrates a block diagram of an example, non-limiting system 200 including a knowledge graph, a hypergraph, a foundation model, and a database that facilitates coherent hyperedges for document QA in accordance with one or more embodiments described herein. As shown, the system 200 can, in some cases, comprise the same components as the system 100, and can further comprise a knowledge graph 202, an extraction component 204, and a database 206.

In various embodiments, the extraction component 204 can extract the entities from the information source 108. In various instances, the extraction component 204 can extract one or more entities from the information source 108 using any suitable document searching technique.

As a non-limiting example, the extraction component 204 can apply any suitable keyword-based document searching technique to the information source 108. In such cases, the extraction component 204 can identify (e.g., via named entity recognition) one or more keywords that are contained or recited in the natural language question 120, and the extraction component 204 can search the information source 108 for whichever (if any) sections (e.g. pages, paragraphs, subsections) also contain or recite those one or more keywords.

As yet another non-limiting example, the graph component 112 can apply any suitable probability-based document searching technique to the information source 108. For instance, the graph component 112 can utilize a Term Frequency-Inverse Document Frequency (TF-IDF) searching technique. As another instance, the graph component 112 can utilize a Best Match 25 searching technique.

Regardless of the type of document searching technique that is implemented, the graph component 112 can search through the information source 108, so as to identify one or more entities. In various instances, the extraction component 204 can identify an entity type (e.g., city, chemical, material, etc.) of each of the entities. In some cases, the extraction component 204 can extract any suitable data from the information source 108.

As a non-limiting example, the extraction component 204 can extract text from information source 108 (e.g., extract a caption of an image, extract one or more paragraphs). As another non-limiting example, the extraction component 204 can extract figures or drawings from information source 108 (e.g., extract a diagram). As yet another non-limiting example, extraction component 204 can extract tables from information source 108 (e.g., extract a data table, extract a chart). As still another non-limiting example, the extraction component 204 can extract metadata from information source 108 (e.g., extract authors, extract a unique identifier of a document, extract the document type, extract modification dates, extract a publisher of a document).

In any case, the information source 108 can be considered as comprising a plurality of isolated information. Accordingly, the extraction component 204 can extract such isolated information (e.g., text, figures, tables, metadata) from information source 108. Thus, the extraction component 204 can extract the entities from the extracted isolated information of information source 108. For instance, extraction component 204 can utilize any suitable natural language processing techniques (e.g., via named entity recognition) to extract such entities from information source 108.

In various cases, generating hypergraph 114 can comprise generating knowledge graph 202. In various embodiments, the graph component 112 can generate knowledge graph 202 based on the entities and relationships between the entities extracted by extraction component 204. The nodes of knowledge graph 202 can represent the entities and the edges of knowledge graph 202 can be pair-wise relationships between the nodes (e.g., pair-wise relationships between the entities extracted from information source 108). In other words, the edges of knowledge graph 202 can represent binary relationships between two entities. In various cases, the knowledge graph 202 can be any suitable graph data structure having nodes and edges, which can represent whatever information is described or conveyed by the information source 108.

In various aspects, the edges of knowledge graph 202 can be associated with respective probabilistic weights. That is, the respective probabilistic weights associated with the edges of knowledge graph 202 can quantify a probability that the nodes are coherently related. Specifically, the respective probabilistic weights can define a probability that two nodes in the respective edge are coherently related.

In various embodiments, the graph component 112 can generate the hypergraph 114 from the knowledge graph 202. Specifically, the graph component 112 can construct hypergraph 114 based on the respective probabilistic weights of the edges of knowledge graph 202. Therefore, hypergraph 114 can represent the information source 108 based on the respective probabilistic weights associated with the edges that indicate a probability of coherence between nodes.

In various embodiments, the hypergraph 114 can be stored in database 206. The database 206 can be any suitable database that is capable of storing graph-like structures, relationships, or queries (e.g., graph databases, document stores, relational databases). In various instances, the database 206 can be deployed in any suitable manner (e.g., cloud-based, private cloud, hybrid cloud, on-premise, managed service, database as a service). In any case, the hypergraph 114 can be accessed from database 206 in response to receiving natural language question 120.

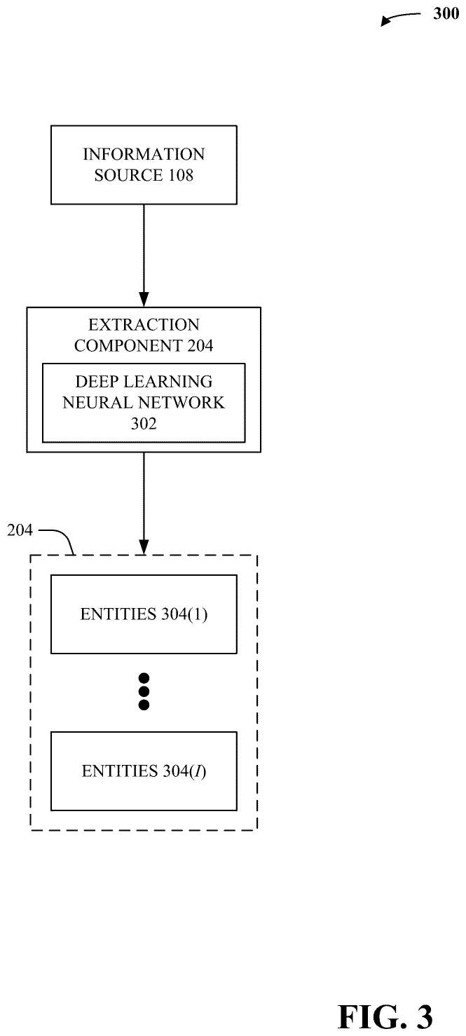

FIG. 3 illustrates an example, non-limiting block diagram 300 of extracting entities from an information source in accordance with one or more embodiments described herein.

In various embodiments, the extraction component 204 can extract the entities from information source 108 via any suitable natural language processing methods. For instance, extraction component 204 can utilize a deep learning neural network 302 to extract the entities and relationships between the entities.

In various embodiments, the extraction component 204 can electronically store, electronically maintain, electronically control, or otherwise electronically access the deep learning neural network 302. In various instances, the deep learning neural network 302 can have or otherwise exhibit any suitable deep learning internal architecture. For instance, the deep learning neural network 302 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be transformer layers, whose learnable or trainable parameters can be input-state weight matrices or hidden-state weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

Regardless of the specific internal architecture (e.g., the specific number, types, or organization of layers) implemented within the deep learning neural network 302, the deep learning neural network 302 can be configured for named entity recognition. In other words, the deep learning neural network 302 can be configured to receive information source 108 (which can be accompanied by any suitable numerical or graphical data) as input and to identify and classify entities 304 (e.g., names of people, organizations, locations, etc.) within the inputted information source, where such textual data is from information source 108.

In various embodiments, the extraction component 204 (e.g., the deep learning neural network 302) can output any suitable number of entities identified in information source 108. For instance, in various embodiments, the entities 304 can comprise i entities, for any suitable positive integer i>1: an entity 304(1) to an entity 304(i). In various aspects, the entities 304 can be any suitable electronic data (e.g., one or more scalars, one or more vectors, one or more matrices, one or more tensors, one or more character strings, or any suitable combination thereof). In various aspects, the entities 304 can be any suitable general or generic feature, aspect, property, characteristic, or category that is extracted from information source 108.

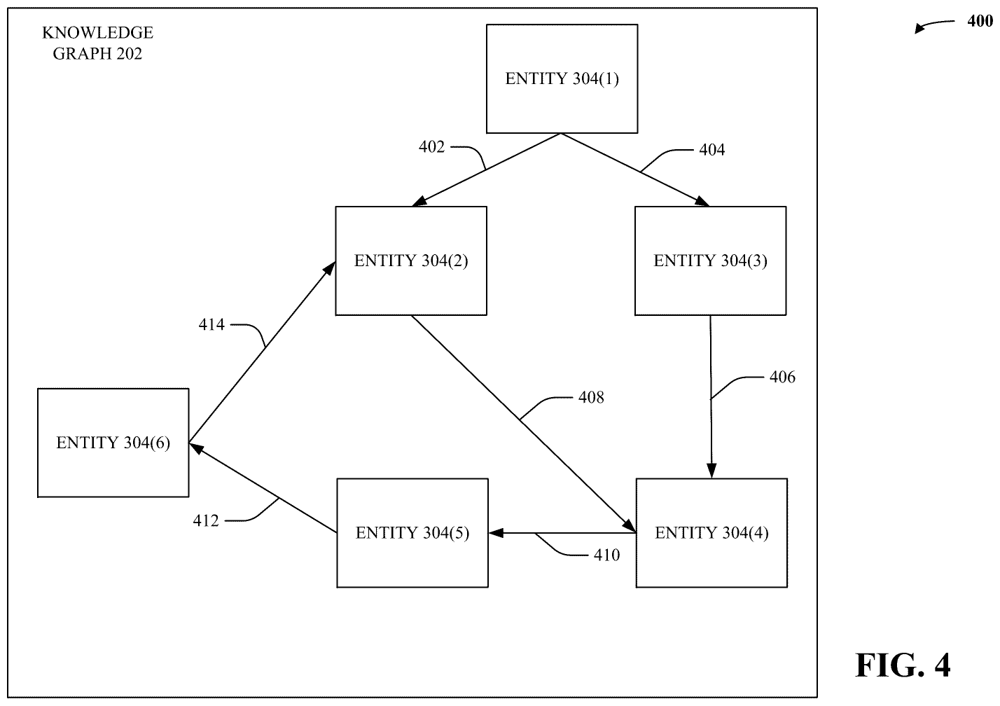

FIG. 4 illustrates an example, non-limiting block diagram 400 of a knowledge graph in accordance with one or more embodiments described herein.

Depicted in FIG. 4 is a non-limiting example of knowledge graph 202. Note that, although knowledge graph 202 is depicted as comprising six entities with a set of relations between such entities, knowledge graph 202 can comprise any suitable number of entities 304 in any suitable fashion via any suitable number of relations that represents whatever information is described or conveyed by the information source 108. That is, the structure of entities and relations of knowledge graph 202 can depend on the information source 108 that is received or accessed. In other words, knowledge graph 202 can comprise any suitable number of nodes in any suitable fashion via any suitable number of edges.

As shown in FIG. 4, knowledge graph 202 can comprise nodes that represent entities 304 and edges that represent relations between two nodes. The edges of knowledge graph 202 can be considered as the relations between the entities 304. In various aspects, entity 304(1) can have a relation 402 with entity 304(2) or a relation 404 with entity 304(3). Further, in various aspects, the entity 304(2) can have a relation 406 with entity 304(4), the entity 304(3) can have a relation 408 with entity 304(4), the entity 304(4) can have a relation 410 with entity 304(5), the entity 304(5) can have a relation 412 with entity 304(6), and the entity 304(6) can have a relation 414 with entity 304(2). In various embodiments, the relations between entities 304 can be semantic relations (e.g., convey interactions, dependencies, or attributes that exist between the entities 304).

As a non-limiting example, suppose that the relation 402 is a “part-of” relation, and suppose that the entity 304(1) represents a car engine and the entity 304(2) represents a specific engine part (e.g., a piston). As another non-limiting example, suppose that the relation 410 is a “employ-of” relation, and suppose that the entity 304(4) represents a person and the entity 304(5) represents an organization. As yet another non-limiting example, suppose that the relation 410 is a “located-in” relation, and suppose that the entity 304(6) represents a city and the entity 304(4) represents a state.

In various embodiments, the edges of knowledge graph 202 can be associated with respective probabilistic weights that quantify the probability of coherence between two nodes. As a non-limiting example, the probabilistic weight for relation 410 can be 0.98, where the relation 404 is a “authored-by” relation, and wherein the entity 304(1) represents a person and the entity 304(3) represents a research paper. That is, the probability of coherence that the person is linked to the research paper is 0.98.

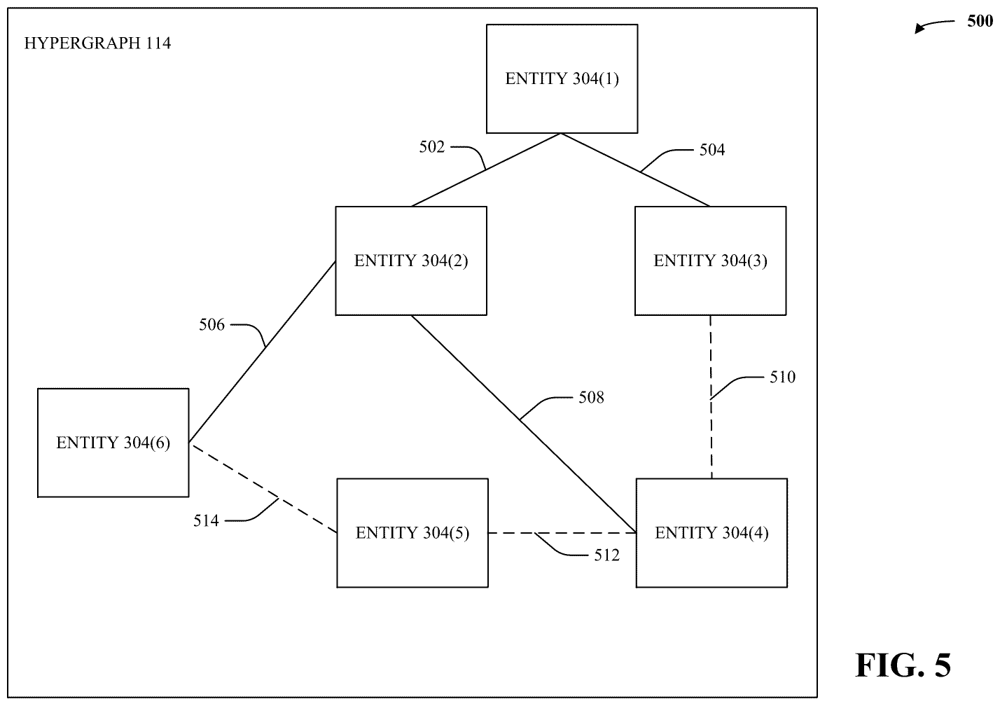

FIG. 5 illustrates an example, non-limiting block diagram 500 of a hypergraph in accordance with one or more embodiments described herein.

Depicted in FIG. 5 is a non-limiting example of hypergraph 114. Note that, although hypergraph 114 is depicted as comprising six entities and two hyperedges that represent relations between such entities, hypergraph 114 can comprise any suitable number of entities 304 in any suitable fashion via any suitable number of hyperedges that represents whatever information is described or conveyed by the information source 108. That is, the structure of entities and relations of hypergraph 114 can depend on the information source 108 that is received or accessed. In other words, hypergraph 114 can comprise any suitable number of nodes in any suitable fashion via any suitable number of hyperedges.

In various aspects, hypergraph 114 can comprise nodes that represent entities 304 and hyperedges that represent relations between two or more of the nodes. That is, a hyperedge of hypergraph 114 can represent a relation between two or more entities of entities 304. In some cases, a hyperedge can comprise more than one relation between entities. Further, the relations of the more than one relation can differ between each other (e.g., a hyperedge comprises a “part-of” relation and a “located-in relation). In other instances, the relations of the more than one relation can be identical (e.g., a hyperedge comprises a first “part-of” relation and a second “part-of” relation).

As shown in FIG. 5, in various aspects, the hypergraph 114 can comprise a first hyperedge that represents relations between entity 304(1), entity 304(2), entity 304(3), entity 304(4), and entity 304(5). That is, the first hyperedge can comprise relation 502 between entity 304(1) and entity 304(2), relation 504 between entity 304(1) and entity 304(3), relation 506 between entity 304(2) and entity 304(6), and relation 508 between entity 304(2) and entity 304(4). Further as shown in FIG. 5, the hypergraph 114 can comprise a second hyperedge that represents relations between entity 304(3), entity 304(4), entity 304(5), and entity 304(6). That is, the second hyperedge can comprise relation 510 between entity 304(3) and entity 304(4), relation 512 between entity 304(4) and entity 304(5), and relation 514 between entity 304(5) and entity 304(6). In various embodiments, the relations between entities 304 can be semantic relations (e.g., convey interactions, dependencies, or attributes that exist between the entities 304).

As a non-limiting example, suppose that in the first hyperedge, relation 502 is a “part-of” relation, relation 504 is a “manufactured-by” relation, where the entity 304(1) represents a car engine, the entity 304(2) represents a specific engine part (e.g., a piston), and the entity 304(3) represents a motor company.

As another non-limiting example, suppose that in the second hyperedge, relation 510 is a “collaborate on” relation, relation 512 is a “funded-by” relation, and relation 514 is a “located-in” relation. Further suppose that the entity 304(3) represents a person, the entity 304(3) represents a research project, the entity 304(5) represents an organization, and the entity 304(6) represents a city.

In various embodiments, the hyperedges of hypergraph 114 can be associated with respective probabilistic weights that quantify the probability of coherence between the nodes in the hyperedge. As a non-limiting example, the probabilistic weight for the first hyperedge can be 0.96. That is, the probability that all nodes in the first hyperedge are coherently linked is 0.96.

In various embodiments, the hypergraph 306 can comprise the same structure as the knowledge graph 202. Specifically, in cases that the hypergraph 114 is generated from knowledge graph 202, the hypergraph 114 can comprise the same entities and relations (e.g., the same nodes and relations) as knowledge graph 202, and can further comprise hyperedges that comprise two or more of the entities and/or one or more of the relations.

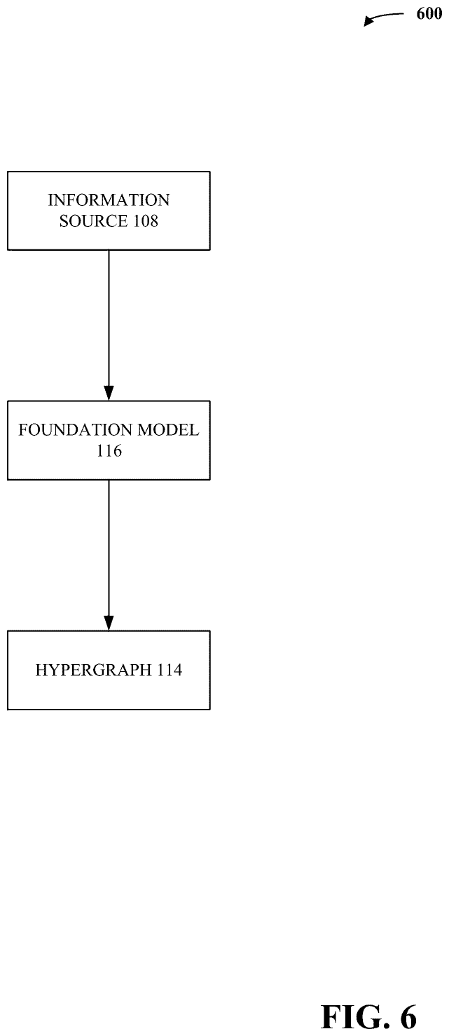

FIG. 6 illustrates an example, non-limiting block diagram 600 of generating a hypergraph via a foundation model in accordance with one or more embodiments described herein.

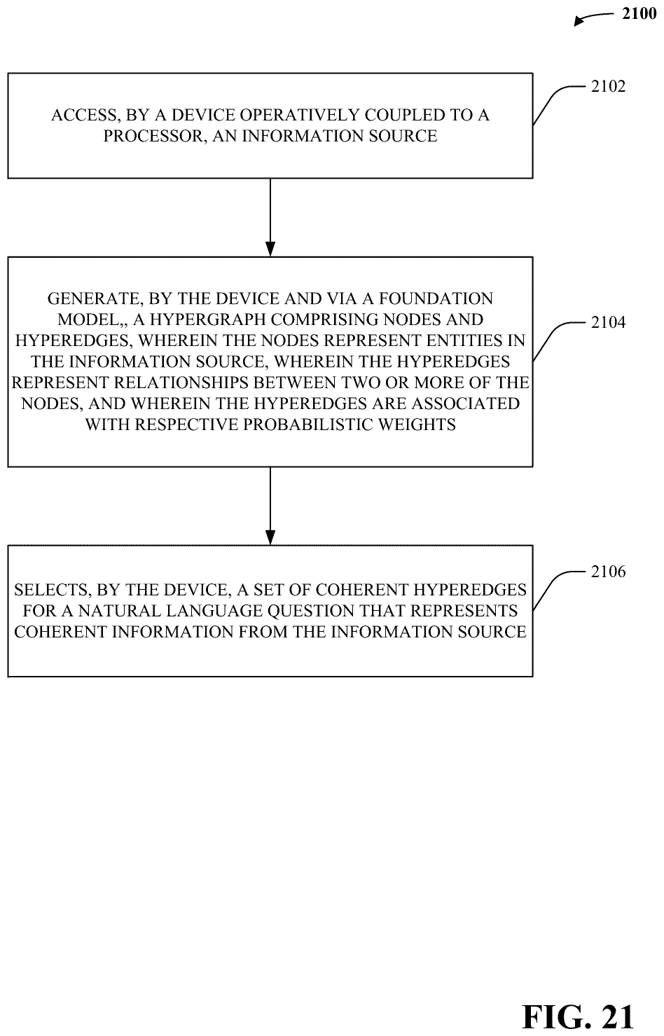

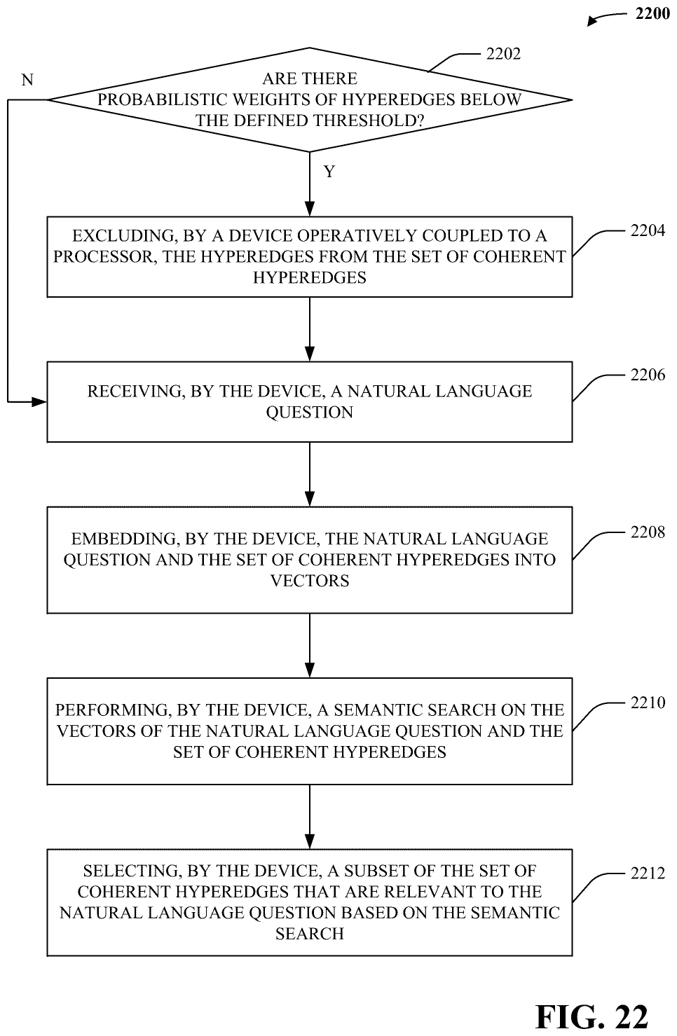

In various embodiments, the foundation model 116 can undergo training to generate hypergraph 114 based on information source 108. Non-limiting aspects of training foundation model 116 are described with respect to FIGS. 21-22.

In various cases, the hypergraph 114 can be generated via foundation model 116. Alternatively, the hypergraph 114 can be generated from knowledge graph 202 based on the probabilistic weights of the edges of knowledge graph 202. In various embodiments, generating hypergraph 114 via foundation model 116 can comprise the foundation model 116 receiving as input information source 108 and producing as output hypergraph 114. Additionally, the foundation model 116 can further determine the respective probabilistic weights associated with the hyperedges of hypergraph 114 based on information source 108. In various aspects, the graph component 112 can electronically execute the foundation model 116 on the information source 108. In various instances, such execution can cause the foundation model 116 to produce hypergraph 114 and respective probabilistic weights associated with the hyperedges of hypergraph 114.

In various embodiments, the selection component 118 can filter or select a set of coherent hyperedges from the hypergraph 114 based on the respective probabilistic weights associated with the hyperedges of hypergraph 114. In various aspects, the set of coherent hyperedges can be stored in database 206 for later retrieval. That is, in response to receiving natural language question 120, the set of coherent hyperedges can be electronically accessed from the database 206.

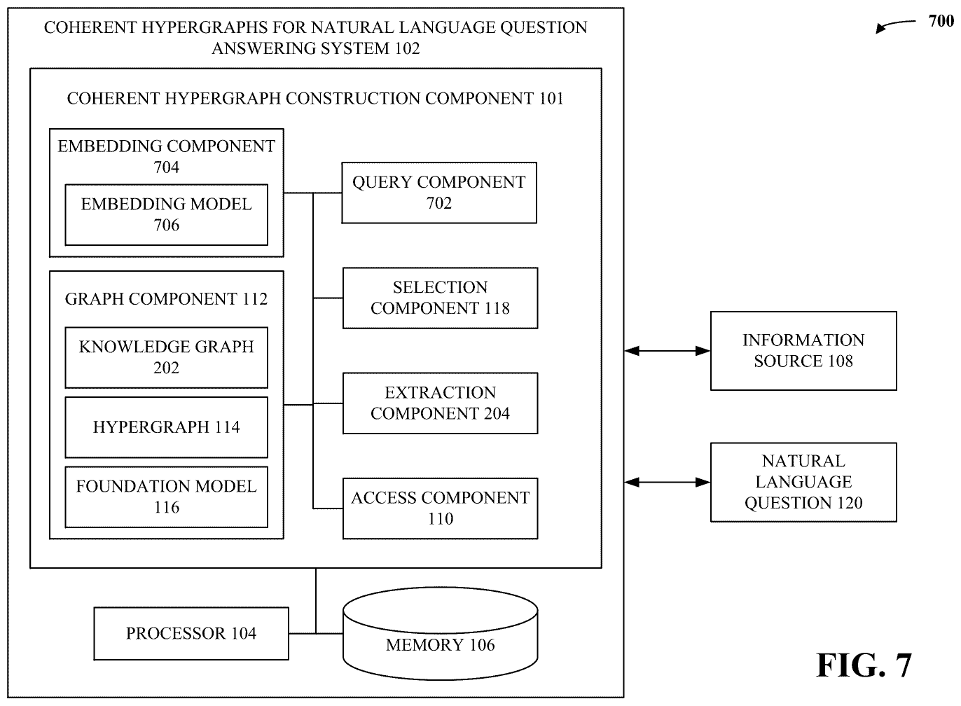

FIG. 7 illustrates a block diagram of an example, non-limiting system 700 including a query component, an embedding component, and an embedding model that facilitates coherent hyperedges for document QA in accordance with one or more embodiments described herein. As shown, the system 700 can, in some cases, comprise the same components as the system 200, and can further comprise a query component 702, an embedding component 704, and an embedding model 706.

In various embodiments, the embedding component 704 can electronically store, electronically maintain, electronically control, or otherwise electronically access the embedding model 706. In various aspects, the embedding component 704 can electronically access the hypergraph 114. In some cases, the embedding component 704 can electronically access the hypergraph 114 from database 206.

In various embodiments, the embedding component 704 can electronically execute the embedding model 706 on the hypergraph 114. In particular, the embedding component 704 can electronically execute the embedding model 706 on the set of coherent hyperedges of hypergraph 114 that are selected by selection component 118 based on the respective probabilistic weights associated with the hyperedges. In various instances, such execution can cause the embedding model 706 to produce a set of embeddings of the hypergraph 114.

Furthermore, the embedding component 704 can electronically execute the embedding model 706 on the natural language question 120. In various instances, such execution can cause the embedding model 706 to produce a set of embeddings of the natural language question 120.

In various embodiments, the selection component 118 can electronically access the embeddings generated by executing embedding model 706 on natural language question 120 and hypergraph 114. Accordingly, the selection component 118 can employ a semantic search on the embeddings of natural language question 120 and hypergraph 114. The semantic search can comprise comparing the embeddings of the natural language question 120 to the embeddings of the hypergraph 114 to find similar vectors between the embeddings. Therefore, the selection component 118 can determine which hyperedges of the set of coherent hyperedges are relevant to the natural language question 120 based on the semantic search.

In various embodiments, the selection component 118 can determine which (if any) of the embeddings of the set of coherent hyperedges are sufficiently similar (e.g., in terms of Euclidean distance or cosine similarity) to the embedding of the natural language question 120. If the embedding of any given hyperedge from the set of coherent hyperedges is within any suitable threshold level of similarity of the embedding of the natural language question 120, then that given hyperedge can be considered as being (e.g., as containing textual, numerical, or graphical data that is) substantively relevant or otherwise related to the natural language question 120.

In various aspects, the query component 702 can identify an answer for any given natural language question regarding the information source 108, by leveraging the set of coherent hyperedges that is selected by the selection component 118.

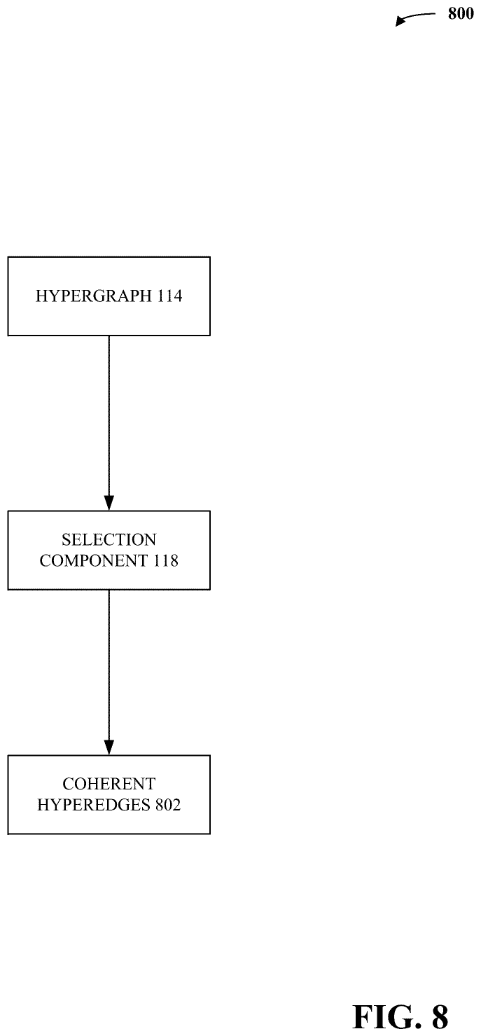

FIG. 8 illustrates an example, non-limiting block diagram 800 of generating coherent hyperedges in accordance with one or more embodiments described herein.

In various embodiments, the selection component 118 can receive hypergraph 114 and the respective probabilistic weights associated with the hyperedges of hypergraph 114. Accordingly, the selection component 118 can filter or select a set of coherent hyperedges 802 from the hypergraph 114 based on the respective probabilistic weights associated with the hyperedges of hypergraph 114. Specifically, the selection component 118 can select, from the hyperedges of hypergraph 114, the set of coherent hyperedges 802 based on defined threshold of the respective probabilistic weights. In various aspects, the defined threshold can be any suitable threshold for determining coherence of the hyperedges. For example, the defined threshold can be user-defined to meet a desired level of coherence in the set of coherent hyperedges 802.

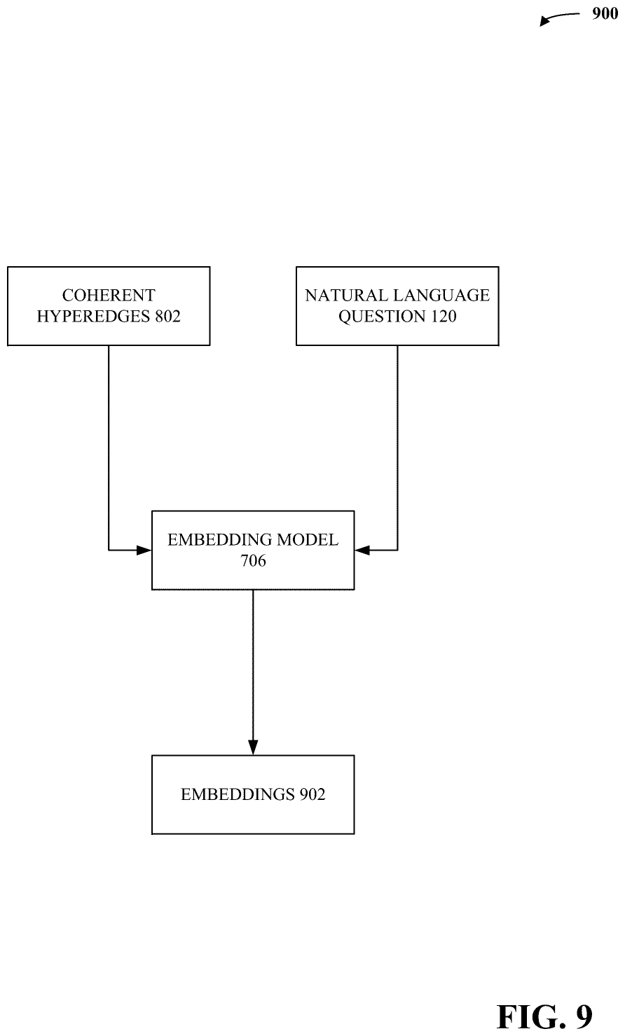

FIG. 9 illustrates an example, non-limiting block diagram 900 of generating embeddings in accordance with one or more embodiments described herein.

In various embodiments, the embedding model 706 can receive as input the set of coherent hyperedges 802 and the natural language question 120. Therefore, the embedding model 706 can produce as output embeddings 902. The embeddings 902 can comprise embeddings of the set of coherent hyperedges 802 and embeddings of the natural language question 120.

In various aspects, the embeddings 902 of hypergraph 114 and the embeddings of natural language question 120 can comprise any suitable format (e.g., latent vector representations). For instance, the embeddings 902 can be numerical vectors representing the natural language question 120 or the nodes, hyperedges, or subgraphs of hypergraph 114. In any case, the embedding model 706 can comprise any suitable internal architecture (e.g., a deep learning neural network, a hypergraph neural network) and can employ any suitable embedding technique to learn and produce the embeddings 902.

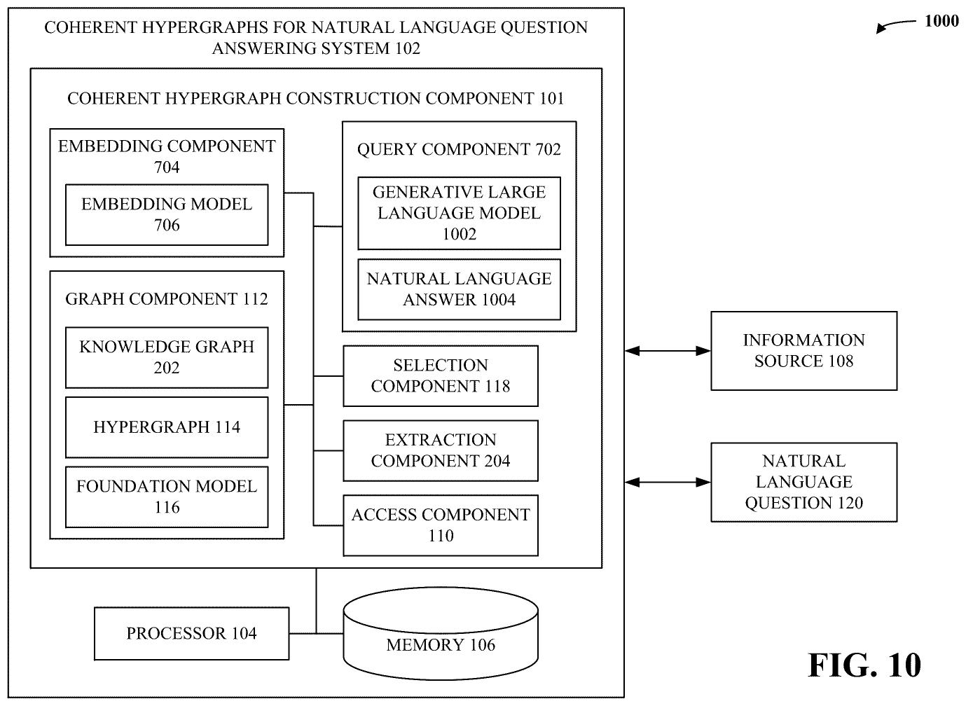

FIG. 10 illustrates a block diagram of an example, non-limiting system 1000 including a generative large language model and a natural language answer that facilitates coherent hyperedges for document QA in accordance with one or more embodiments described herein. As shown, the system 1000 can, in some cases, comprise the same components as the system 700, and can further comprise a generative large language model and a natural language answer 1004.

In various embodiments, the access component 110 can electronically receive, electronically retrieve, or otherwise electronically access, from any suitable data structure or source, the natural language question 120. In various aspects, the natural language question 120 can be any suitable plain text question that asks about any aspect of information source 108. As a non-limiting example, if the information source 108 pertains to healthcare, the natural language question 120 can ask what the symptoms of a disease are. As another non-limiting example, if the information source 108 pertains to travel, the natural language question 120 can ask what the top-rated hotels are in a city. In various instances, the natural language question 120 can be provided or inputted by a user via any suitable human-computer interface device (e.g., via a keyboard, keypad, touchscreen, or voice control system).

In various aspects, the query component 702 can electronically store, electronically maintain, electronically control, or otherwise electronically access the generative LLM 1002. In various instances, the generative LLM 1002 can have or otherwise exhibit any suitable deep learning internal architecture. For instance, the generative LLM 1002 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be transformer layers, whose learnable or trainable parameters can be input-state weight matrices or hidden-state weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

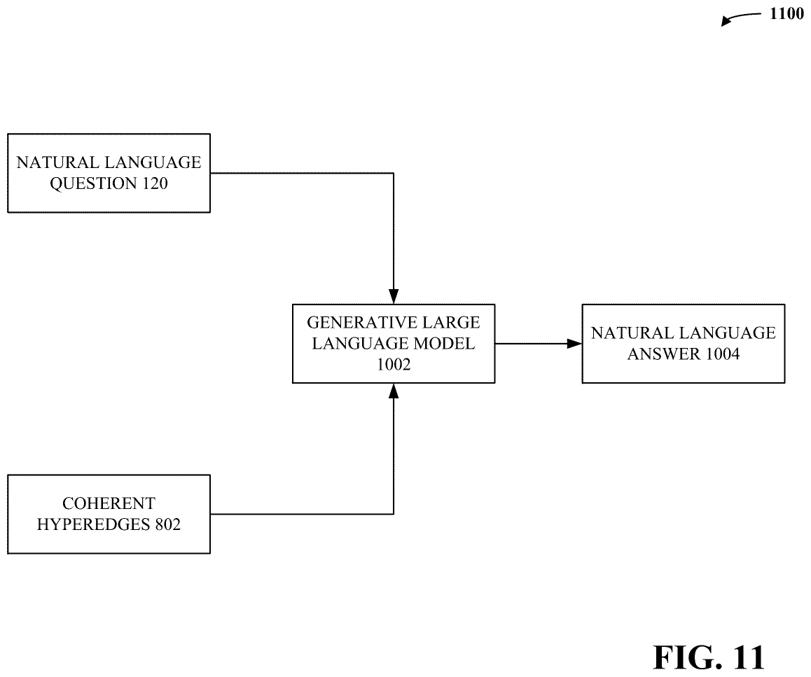

Regardless of the specific internal architecture (e.g., the specific number, types, or organization of layers) implemented within the generative LLM 1002, the generative LLM 1002 can be configured for question-answering. That is, the generative LLM 1002 can be configured to receive natural language questions and the set of coherent hyperedges 802 as input and to produce corresponding natural language answers as output. In particular, the generative LLM 1002 can be configured to receive a subset of the set of coherent hyperedges that are selected by selection component 118 that are deemed relevant to natural language answer 1004. Accordingly, by leveraging the generative LLM 1002 and the set of coherent hyperedges 802, the query component 702 can generate the natural language answer 1004. That is, by executing the natural language question 120 over the set of coherent hyperedges 802, the query component 702 can generate the natural language answer 1004. Non-limiting aspects are described with respect to FIG. 11.

FIG. 11 illustrates an example, non-limiting block diagram 1100 showing how a natural language answer can be generated based on a natural language query and set of coherent hyperedges in accordance with one or more embodiments described herein.

In various embodiments, as mentioned above, the natural language question 120 can be a plain text interrogative sentence that asks about information pertaining to information source 108 and that is provided by a user. In various aspects, the query component 702 can electronically execute the generative LLM 1002 on the natural language question 120 and set of coherent hyperedges 802. In various instances, such execution can cause the generative LLM 1002 to produce the natural language answer 1004. More specifically, the query component 702 can feed or route the natural language question 120 to an input layer of the generative LLM 1002. In various aspects, the natural language question 120 can complete a forward pass through one or more hidden layers of the generative LLM 1002. In various instances, an output layer of the generative LLM 1002 can calculate or compute the natural language answer 1004, based on activation maps or feature maps generated by the one or more hidden layers.

In various aspects, generating the natural language answer 1004 can comprise electronically executing the natural language answer 1004 over the set of coherent hyperedges 802. In various instances, such execution can be facilitated in any suitable fashion (e.g., in SQL fashion, in SPARQL fashion, in GraphQL fashion, in Cypher fashion). In any case, such execution can yield the natural language answer 1004. In various aspects, the natural language answer 1004 can be any suitable electronic data (e.g., one or more scalars, one or more vectors, one or more matrices, one or more tensors, one or more character strings, or any suitable combination thereof) that can be considered as representing whatever information that was asked or requested in the natural language question 120. As a non-limiting example, consider again the above instance where the natural language question 120 can ask, if the information source 108 pertains to healthcare, what the symptoms of a disease are. In such case, the natural language answer 1004 can recite or identify one or more potential symptoms of the disease that are enumerated in the set of coherent hyperedges 802.

In various aspects, the query component 702 can electronically render the natural language answer 1004 on any suitable electronic display (e.g., screen), so that the natural language answer 1004 can be visible by the user. In other instances, the query component 702 can electronically transmit the natural language answer 1004 to any other suitable computing device (e.g., a smart phone) associated with the user, so that the user can become aware of the natural language answer 1004.

Accordingly, as described herein, the coherent hypergraphs for natural language question answering system 102 can subsequently leverage the set of coherent hyperedges 802 so as to answer real-world questions about the information source 108, or any other suitable information source, that real-world users might have.

In order for the coherent hypergraphs for natural language question answering system 102 to function accurately, correctly, or reliably, the generative LLM 1002 can first undergo training, as described with respect to FIGS. 21-22.

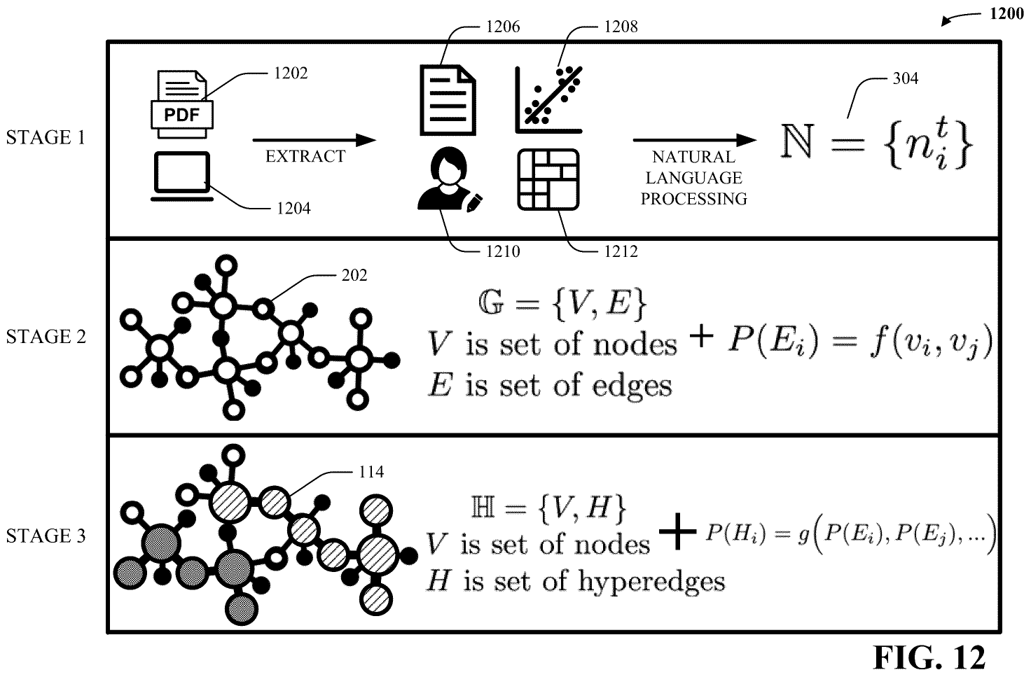

FIG. 12 illustrates an example, non-limiting diagram 1200 that facilitates coherent hyperedges for document QA in accordance with one or more embodiments described herein.

Depicted by FIG. 12 is a multi-stage flow diagram that facilitates various embodiments described herein. For instance, as shown, stages one, stage two, and stage three can comprise generating hypergraph 114 from knowledge graph 202. In particular, stage one can comprise extracting and identifying entities 304. In various aspects, extracting and identifying entities 304 can comprise receiving information source 108. For instance, the information source 108 can be a document 1202 or a webpage 1204. In various aspects, extracting and identifying entities 304 can comprise extracting isolated information from the information source 108. As a non-limiting example, the extraction component 204 can extract text 1206, figures 1208, metadata 1210, or tables 1212 from information source 108. Accordingly, the extraction component 204 can utilize natural language processing to identify the entities 304. For instance, the extraction component 204 can electronically execute the deep learning neural network 402 on the isolated information from the information source 108 to extract the entities 304. The entities 304 can be denoted by

$$ℕ = \{ {n}_{i}^{t} \} ,$$

where each entity n can be of type t, and i denotes a running index. Stage two can comprise generating knowledge graph 202 based on the entities 304. The knowledge graph 202 can be defined by [symbol] ={V, E}, where V denotes the set of nodes and E denotes the set of edges of knowledge graph 202.

In various embodiments, the entities 304 can comprise entities extracted by extraction component 204 or user-identified entities. That is, the user-identified entities can be provided or inputted by a user via any suitable human-computer interface device (e.g., via a keyboard, keypad, touchscreen, or voice control system). Accordingly, the set of nodes can be defined by V= [symbol] ∪ [symbol] , where [symbol] denotes the user-identified entities.

In various aspects, the respective probabilistic weight associated with the edges of knowledge graph 202 can be defined by P(Eᵢ)=f(vᵢ, vⱼ), where P(Eᵢ) quantifies the probability that node vᵢ and node vⱼ are coherently related. Accordingly, in stage three, based on the respective probabilistic weight P(Eᵢ) associated with each edge of knowledge graph 202, the graph component 112 can generate the hypergraph 114. Specifically, the graph component 112 can determine the hyperedges of hypergraph 114 (e.g., the relations between two or more nodes) based on the respective probabilistic weight P(Eᵢ).

The hypergraph 114 can be defined by [symbol] ={V, H}, where V denotes the set of nodes and H denotes the set of hyperedges. The set of hyperedges can be defined by H={{Eᵢ, Eⱼ, Eₖ}, {E_{i′}, E_{j′}}, . . . }. Note that, this is a mere non-limiting example, and that the set of hyperedges H can comprise any suitable structure (e.g., any suitable number of nodes or hyperedges, any suitable configuration of nodes and hyperedges).

In various aspects, the respective probabilistic weights associated with the set of hyperedges of hypergraph 114 can be defined by P(Hᵢ)=g(P(Eᵢ), P(Eⱼ), . . . ), where P(Hᵢ) quantifies the probability of coherently linking two or more nodes with a hyperedge. In various embodiments, the respective probabilistic weights associated with the set of hyperedges can be a function of proximities between location of entities, specifically between physical or conceptual closeness of the entities within the hyperedge. As a non-limiting example, entities located in a same geographical area can have a higher probability of being coherently related. In various instances, the respective probabilistic weights associated with the set of hyperedges can be a function of proximities between length of information source 108, specifically the size or extent of the information source 108. As a non-limiting example, information source 108 that are longer in length can provide more context or evidence for relationships between nodes, affecting the respective probabilistic weights. In various aspects, the respective probabilistic weights associated with the set of hyperedges can be a function of proximities between thematic entity category, specifically the category or theme to which the entities belong. As a non-limiting example, entities within a same thematic category (e.g., all related to healthcare, all related to semiconductor structures) can have a higher probability of being coherently related.

In any case, based on the respective probabilistic weight P(Hᵢ) associated with each hyperedge of hypergraph 114, the selection component 118 can select a subset of the set of hyperedges H that are coherently related. Specifically, the selection component 118 can filter out hyperedges from the set of hyperedges H that do not meet the defined threshold of coherence between the nodes.

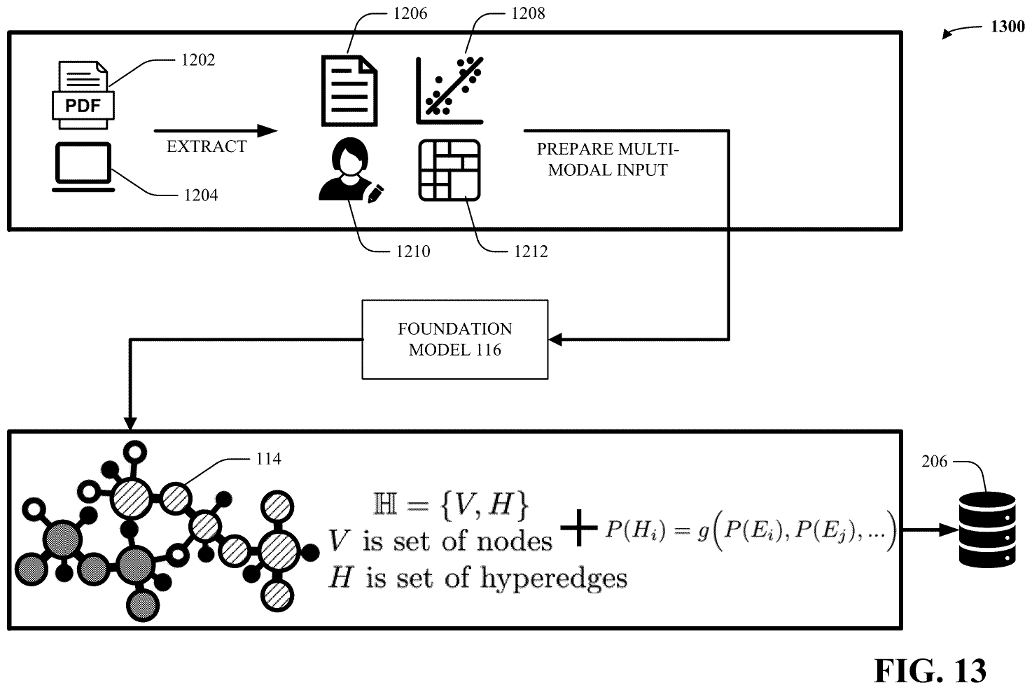

FIG. 13 illustrates an example, non-limiting diagram 1300 that facilitates coherent hyperedges for document QA in accordance with one or more embodiments described herein.

In various embodiments, alternatively to generating the hypergraph 114 from the knowledge graph 202, the hypergraph 114 can be generated via foundation model 116. More specifically, graph component 112 can prepare and generate a multi-modal input from the isolated information of information source 108. Thus, the graph component 112 can input the multi-modal input into foundation model 116. That is, the graph component 112 can electronically execute the foundation model 116 on the multi-modal input to produce hypergraph 114 and the respective probabilistic weights associated with the set of hyperedges of hypergraph 114.

In various aspects, based on the respective probabilistic weight P(Hᵢ) associated with each hyperedge of hypergraph 114, the selection component 118 can select a subset of the set of hyperedges H that are coherently related. Specifically, the selection component 118 can filter out hyperedges from the set of hyperedges H that do not meet the defined threshold of coherence between the nodes. Accordingly, the subset of the set of hyperedges H that are coherently related can be stored in database 206.

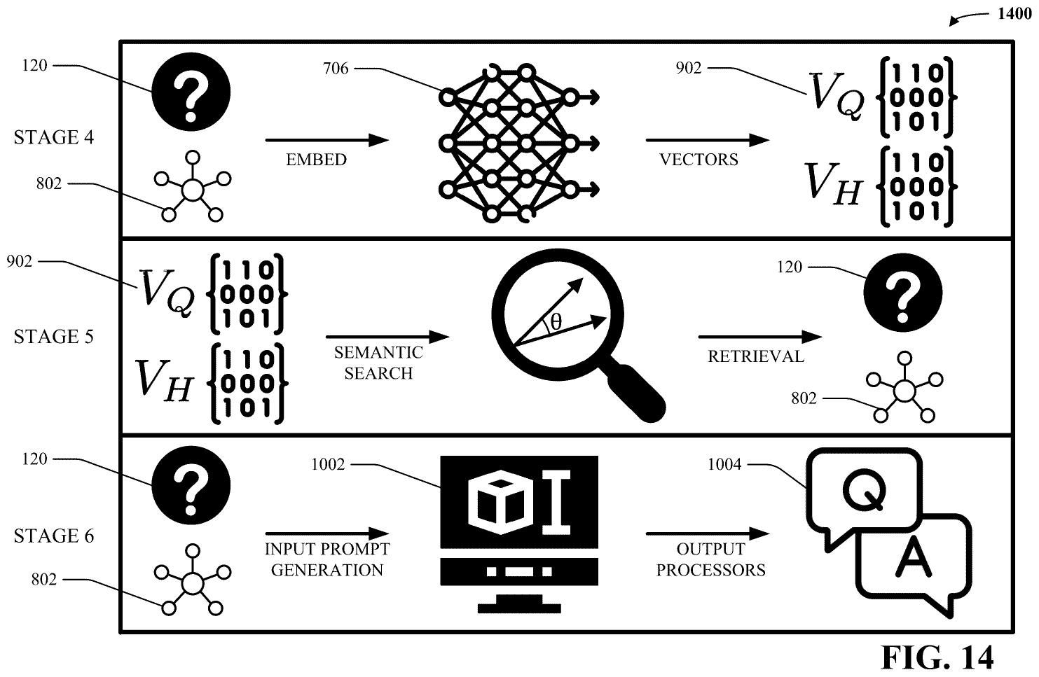

FIG. 14 illustrates an example, non-limiting diagram 1400 that facilitates coherent hyperedges for document QA in accordance with one or more embodiments described herein.

Depicted by FIG. 14 is a multi-stage flow diagram that facilitates various embodiments described herein that can follow various stages described by FIGS. 12 and 13. For instance, as shown, stages four, stage five, and stage six can comprise generating natural language answer 1004 based on natural language question 120 and the set of coherent hyperedges 802. In particular, stage four can comprise embedding, via embedding model 706, the natural language question 120 and the set of coherent hyperedges 802. In various aspects, the embedding component 704 can electronically execute the embedding model 706 on the natural language question 120 and the set of coherent hyperedges 802 to produce vector embeddings. The embedding 1402 of the natural language question 120 can be denoted by V_{Q} and the embeddings 1404 of the set of coherent hyperedges 802 can be denoted by V_{H}.

In various embodiments, stage five can comprise performing a semantic search on the embedding 1402 and embeddings 1404. As a non-limiting example, the selection component 118 can employ vector similarity methods for the semantic search. As another non-limiting example, the selection component 118 can employ k-th nearest clusters for the semantic search. In any case, the selection component 118 can select, based on the semantic search, a subset of the set of coherent hyperedges that are relevant to natural language question 120.

Accordingly, in stage six, the query component 702 can execute the generative LLM 1002 on the natural language question 120 and the subset of the set of coherent hyperedges that are relevant to natural language question 120. In various aspects, the query component 702 can generate an input prompt from the natural language question 120 and the subset of the set of coherent hyperedges, wherein the input prompt can be inputted into generative LLM 1002. Thus, the generative LLM 1002 can output the natural language answer 1004 that corresponds to the natural language question 120.

In various embodiments, the query component 702 can further utilize output processers for quality control of the natural language answer 1004. As a non-limiting example, the query component 702 can implement quality control by removing hateful text, profanity, ethics, biases, and/or relevancy. In various aspects, the generative LLM 1002 can be trained to perform such quality control on the natural language answer 1004. In particular, for example, the generative LLM 1002 can utilize automated evaluation metrics that can be used for iteratively refining the generative LLM 1002 based on the automated evaluation metrics. As another non-limiting example, the generative LLM 1002 can be fine-tuned with additional training datasets that are designed to reduce such biases or unsuitable output. As yet another non-limiting example, the query component 702 can employ post-processing techniques (e.g., rule-based filtering, fact-checking, consistency checking). As still another non-limiting example, the query component 702 can utilize feedback loops that collect feedback from users, and iteratively refine the generative LLM 1002 based on the feedback.

In any instance, the generative LLM 1002 can generate natural language answer 1004 that answers natural language question 120.

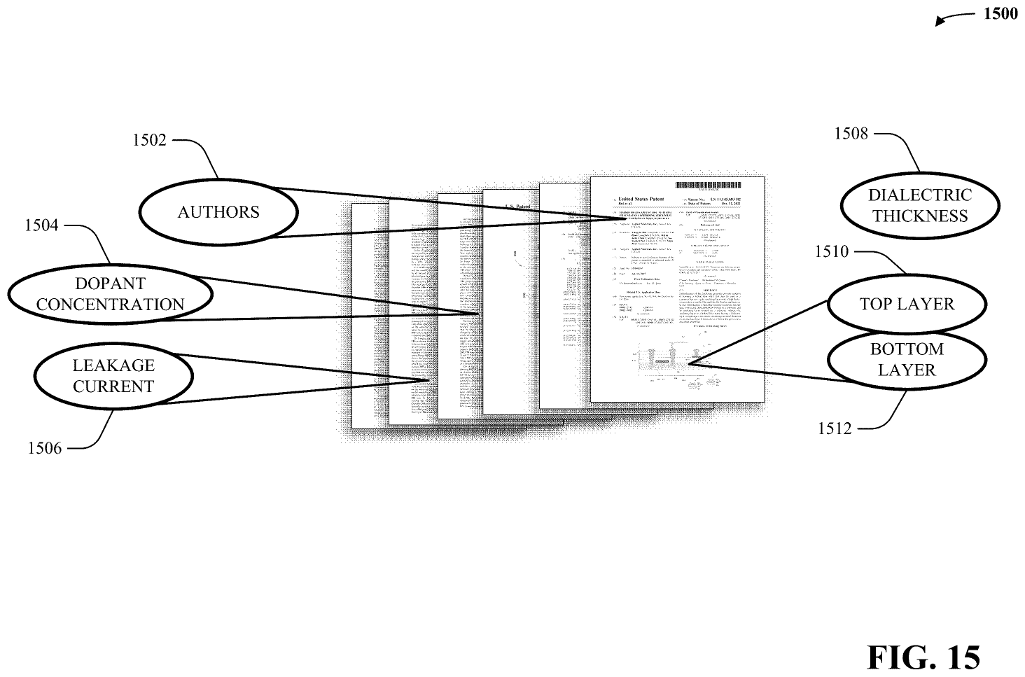

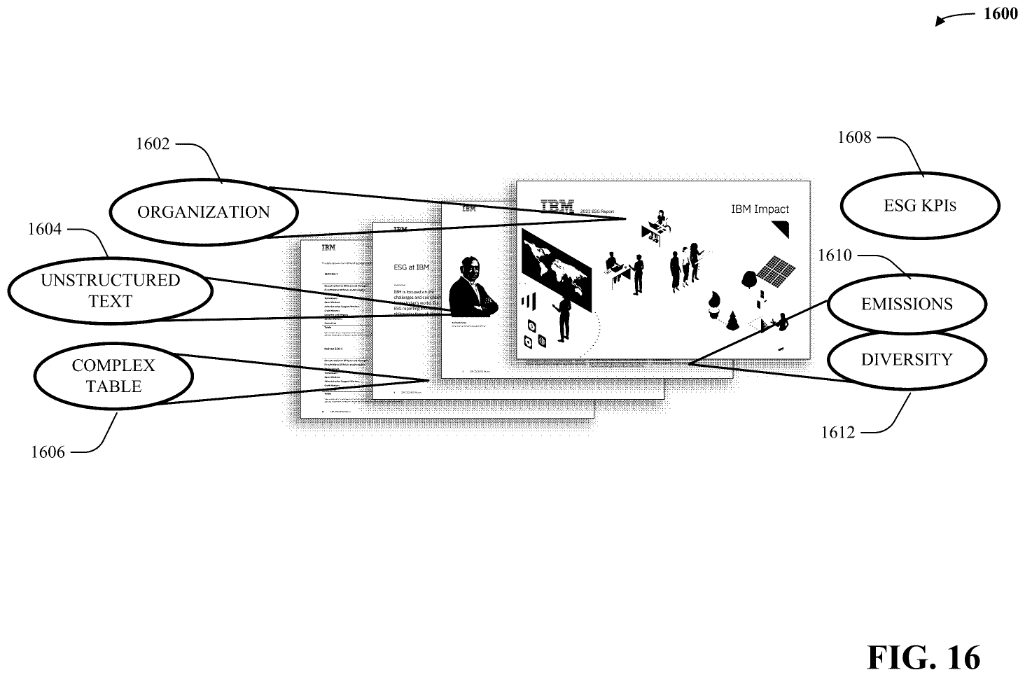

FIGS. 15-16 illustrate example, non-limiting information sources 1500 and 1600 in accordance with one or more embodiments described herein.

FIG. 15 depicts an example non-limiting information source 1500. As shown, the information source 1500 can be a patent application pertaining to a dielectric material. In various aspects, the entities 304 of information source 1500 can be extracted from information source 1500 (e.g., via deep learning neural network 302, via foundation model 116). For instance, as shown, the entities 304 of information source 1500 can include authors 1502, dopant concentration 1504, leakage current 1506, dielectric thickness 1508, a top layer 1510, and bottom layer 1512.

FIG. 16 depicts an example non-limiting information source 1600. As shown, the information source 1600 can be a report published by a company. In various aspects, the entities 304 of information source 1600 can be extracted from information source 1600 (e.g., via deep learning neural network 302, via foundation model 116). For instance, as shown, the isolated information or entities 304 of information source 1600 can include an organization 1602, unstructured text 1604, complex table 1606, economic social governance key point indicators 1608, emissions 1610, and diversity 1612.

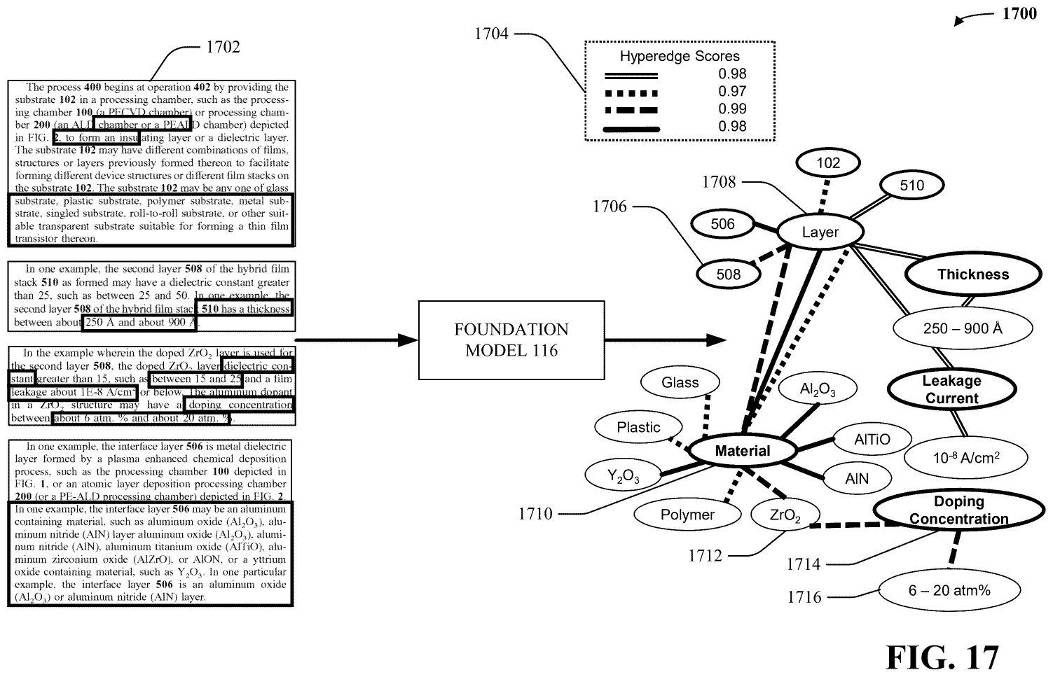

FIG. 17 illustrates an example, non-limiting diagram 1700 of generating a hypergraph from an information source in accordance with one or more embodiments described herein.

As a non-limiting example of generating hypergraph 114 from information source 108, the information source 108 can be a text excerpt 1702 of a patent application pertaining to dielectric material. In various embodiments, the foundation model 116 can receive text excerpt 1702 as input and, in response, generate hypergraph 1706 as output. As shown, the hypergraph 1706 can comprise nodes and hyperedges that represent whatever information conveyed in text excerpt 1702. The hyperedges comprising such nodes can be associated with respective probabilistic weights 1704 that quantify the probability of coherence among the nodes in the respective hyperedge. For instance, a hyperedge of hypergraph 1706 comprises relations between node 1708, node 1710, node 1712, node 1714, and node 1716. Such hyperedge is associated with a probabilistic weight of 0.99.

In various aspects, the selection component 118 can select a subset of the hyperedges based on the respective probabilistic weights 1704. Such subset can be considered as the set of coherent hyperedges 802. For example, a user can define the threshold of coherence to be 0.99. Accordingly, the selection component 118 can exclude the hyperedges comprising a respective probabilistic weight that is lower than 0.99 from the set of coherent hyperedges 802.

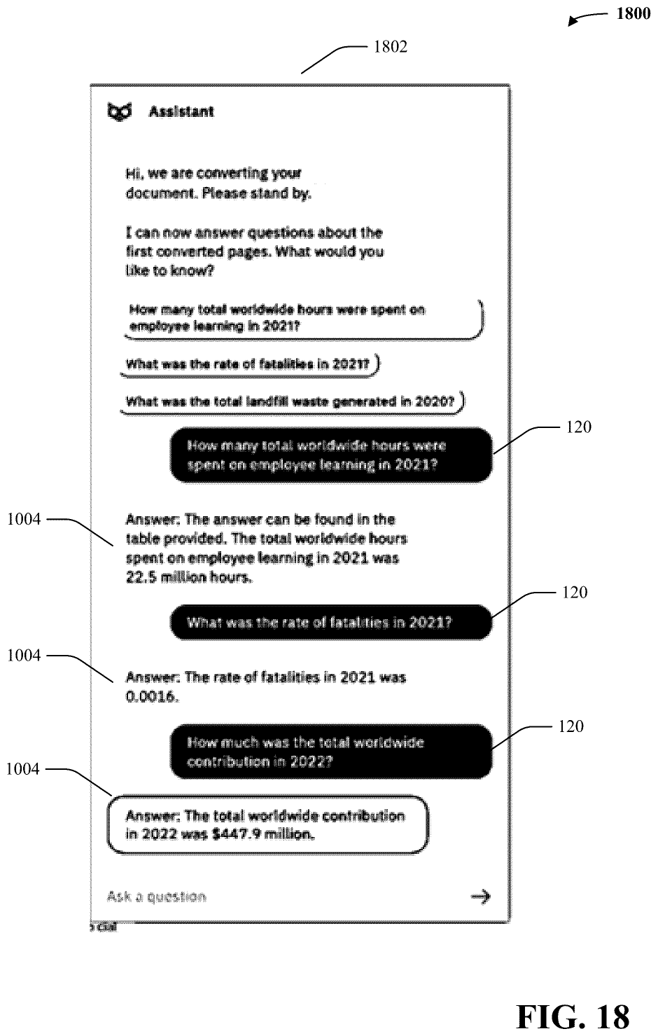

FIG. 18 illustrates an example, non-limiting diagram 1800 of a user chat bot in accordance with one or more embodiments described herein.

As shown in FIG. 18, the natural language answer 1004 can be visually rendered to a user, via any suitable human-computer interface device, in response to the user asking the natural language question 120. In various aspects, the natural language answer 1004 can be displayed to the user in any suitable manner. As a non-limiting example, there can be a user chat bot 1802 that can facilitate communication with the user. Therefore, in response to receiving information source 108 from the user and generating the set of coherent hyperedges 802, the user can ask any suitable number of natural language questions 120 via the human-computer interface device. Accordingly, for each question, the selection component 118 can access the set of coherent hyperedges 802, and select a subset of the set of coherent hyperedges 802 that are relevant to the natural language question 120. Thus, the subset of the set of coherent hyperedges 802 and the natural language question 120 can be input into the generative LLM 1002 to generate the natural language answer 1004.

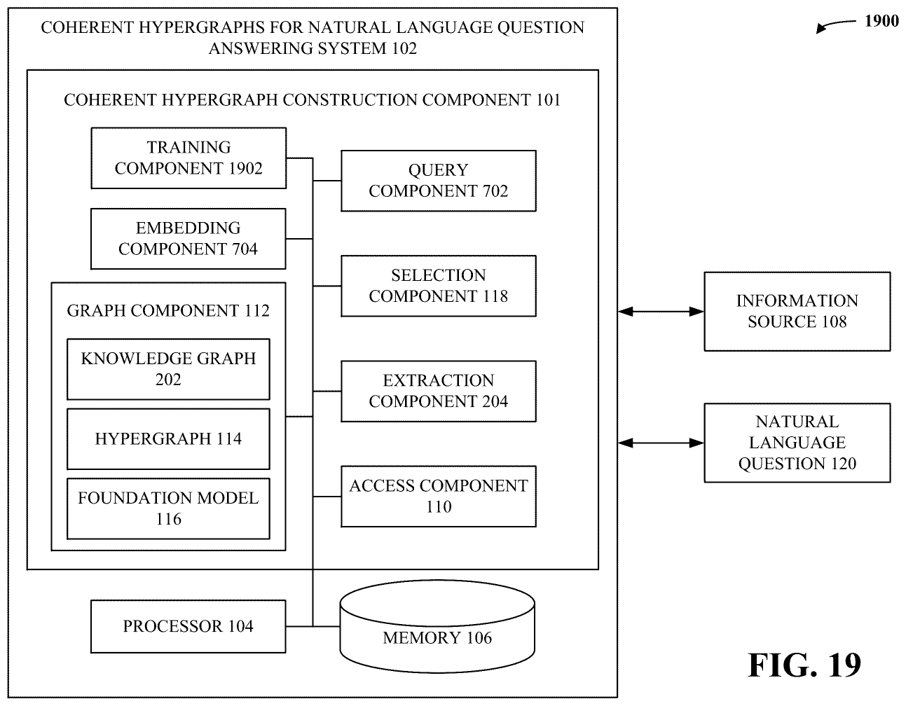

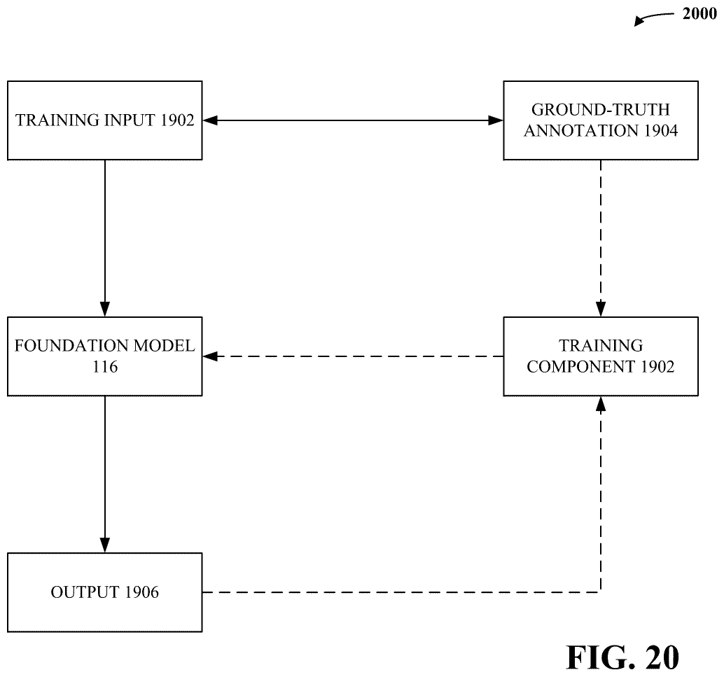

FIG. 19 illustrates a block diagram of an example, non-limiting system 1900 including a training component that facilitates coherent hyperedges for document QA in accordance with one or more embodiments described herein. As shown, the system 1900 can, in some cases, comprise the same components as the system 1000, and can further comprise a training component 1902. In various instances, the training component 1902 can train the deep foundation model 116 using any suitable training paradigm. In some cases, such training can be facilitated in supervised fashion, as described with respect to FIG. 20.

In various cases, if the foundation model 116 has not yet undergone any training, the training component 1902 can randomly initialize the trainable internal parameters (e.g., convolutional kernels, weight matrices, bias vectors) of the foundation model 116. In contrast, if the foundation model 116 has already undergone at least some training, the training component 1902 can refrain from re-initializing the trainable internal parameters of the foundation model 116.

In various aspects, the training component 1902 can execute the foundation model 116 on the information source 108, thereby causing the foundation model 116 to produce some output. In particular, the training component 1902 can feed the information source 108 to an input layer of the foundation model 116, the information source 108 can complete a forward pass through one or more hidden layers of the foundation model 116, and such forward pass can cause an output layer of the foundation model 116 to compute the output based on activations provided by the one or more hidden layers.

Note that the format, size, or dimensionality of the output can be controlled or otherwise dictated by the number, arrangement, or sizes of the neurons or of other internal parameters (e.g., convolutional kernels) that are contained in or that otherwise make up the output layer of the foundation model 116. So, the output can be forced to have any suitable or any desired format, size, or dimensionality, by adding, removing, or otherwise adjusting neurons or other internal parameters to, from, or within the output layer of the foundation model 116. So, the output can be considered as a predicted or inferred hypergraph that the foundation model 116 believes should convey the information of information source 108 (e.g., believes is accurately representative of the information source 108). In various cases, if the foundation model 116 has so far undergone no or little training, the output can be highly inaccurate (e.g., can be very different from corresponding ground-truth hypergraphs).

In any case, the training component 1902 can compute an error or loss (e.g., mean absolute error (MAE), mean squared error (MSE), cross-entropy error) between the output and the ground-truth hypergraphs. In various aspects, the training component 1902 can update the trainable internal parameters of the foundation model 116 by performing backpropagation (e.g., stochastic gradient descent) driven by the computed error or loss.

In various aspects, such training procedure can be repeated for any suitable number of information-source-and-hypergraph pairs. Such training can ultimately cause the trainable internal parameters of the foundation model 116 to become iteratively optimized for accurately inferring hypergraph relations based on inputted information sources. Note that the training component 1902 can implement any suitable training batch sizes, any suitable training termination criteria, or any suitable error, loss, or objective functions.

Furthermore, in various embodiments, the training component 1902 can train the deep learning neural network 302, the embedding model 706, or the generative LLM 1002 using any suitable training paradigm. For instance, the training component 1902 can train the deep learning neural network 302 in a similar fashion to generate entities 304 from information source 108. Instead, however, the deep learning neural network 302 can be trained in a supervised fashion on information-source-and-entities pairs. That is, the deep learning neural network 302 can receive as input an information source, and produce as output a set of entities identified from the information source.

Moreover, for instance, the training component 1902 can train the generative LLM 1002 in a similar fashion to generate entities 304 from information source 108. Instead, however, the generative LLM 1002 can be trained in a supervised fashion on question-and-answer pairs. Specifically, such question-and-answer pairs can further comprise corresponding coherent hyperedges received as training input. That is, the generative LLM 1002 can receive as input a natural language question and a set of coherent hyperedges, and produce as output a natural language answer.

In various embodiments, training the foundation model 116 can comprise two stages. Specifically, the foundation model can be pre-trained on a first training dataset to generate natural language. In various cases, the first training dataset can comprise a plurality of textual data (e.g., corpus, a plurality of documents, natural language text). In various aspects, the foundation model 116 can then be trained on a second training dataset to generate the hypergraph. The second training dataset can comprise textual data and corresponding hypergraphs. For instance, the second training set can comprise a document and a corresponding hypergraph that accurately conveys the information in the document. The second training dataset can comprise any suitable number of textual-data-hypergraph pairs to train the fm 126.

FIG. 20 illustrates an example, non-limiting block diagram 2000 showing how deep learning neural networks can be trained in accordance with one or more embodiments described herein.

In various aspects, prior to beginning training, the training component 1902 can initialize in any suitable fashion (e.g., via random initialization) trainable internal parameters (e.g., convolutional kernels, weight matrices, bias values) of the foundation model 116.

In various embodiments, there can be a training input 2002 and a ground-truth annotation 2004. When it is desired to train the foundation model 116, the training input 2002 can be a training information source, and the ground-truth annotation 2004 can be correct or accurate generated hypergraph that is known or deemed to correspond to the training input 2002.

In any case, the training component 1902 can execute the foundation model 116 on the training input 2002, thereby causing the foundation model 116 to produce an output 2006. More specifically, in some cases, the training component 1902 can feed or route the training input 2002 to the input layer of the foundation model 116, the training input 2002 can complete a forward pass through the one or more hidden layers of the foundation model 116, and the output layer of the foundation model 116 can compute the output 2006 based on activation maps or feature maps provided by the one or more hidden layers of the fm.

Note that the format, size, or dimensionality of the output 2006 can be dictated by the number, arrangement, sizes, or other characteristics of the neurons, convolutional kernels, or other internal parameters of the output layer (or of any other layers) of the foundation model 116. Accordingly, the output 2006 can be forced to have any desired format, size, or dimensionality, by adding, removing, or otherwise adjusting characteristics of the output layer (or of any other layers) of the foundation model 116.

In various aspects, if the output 2006 is produced by the foundation model 116, the output 2006 can be considered as the predicted or inferred hypergraph that the foundation model 116 has generated based on the training input 2002. In various instances, the ground-truth annotation 2004 can be considered as whatever correct or accurate result (e.g., correct or accurate hypergraph) that is known or deemed to correspond to the training input 2002. Note that, if the foundation model 116 has so far undergone no or little training, then the output 2006 can be highly inaccurate. In other words, the output 2006 can be very different from the ground-truth annotation 2004.

In various aspects, the training component 1902 can compute an error (e.g., mean absolute error (MAE), mean squared error (MSE), cross-entropy error) between the output 2006 and the ground-truth annotation 2004. In various instances, the training component 1902 can incrementally update the trainable internal parameters of the foundation model 116 (or of the foundation model 116), via backpropagation (e.g., stochastic gradient descent) based on the computed error.

In various cases, such execution-and-update procedure can be repeated for any suitable number input-annotation pairs. This can ultimately cause the trainable internal parameters of the foundation model 116 to become iteratively optimized for accurately generating hypergraphs. In various aspects, the training component 1902 can utilize any suitable training batch sizes, any suitable error/loss functions, or any suitable training termination criteria.

Although the herein disclosure mainly describes the foundation model 116 as being trained in supervised fashion, this is a mere non-limiting example for case of explanation and illustration. In various embodiments, any other suitable training paradigm can be used to train the foundation model 116 such as unsupervised training or reinforcement learning.

FIG. 21 illustrates a flow diagram of an example, non-limiting computer-implemented method 2100 that can facilitate coherent hyperedges for document QA in accordance with one or more embodiments described herein. In various cases, the coherent hypergraphs for natural language question answering system 102 can facilitate the computer-implemented method 2100.

In various embodiments, act 2102 can include accessing, by a device (e.g., 110) operatively coupled to a processor (e.g., 108), an information source (e.g., 108).

In various aspects, act 2104 can include generating, by the device (e.g., via 112), and via a foundation model (e.g., 116), a hypergraph (e.g., 114) comprising nodes and hyperedges, wherein the nodes represent entities (e.g., 304) in the information source, wherein the hyperedges represent relationships between two or more of the nodes, and wherein the hyperedges are associated with respective probabilistic weights.

In various instances, act 2106 can include selecting, by the device (e.g., via 118), a set of coherent hyperedges (e.g., 802) for a natural language question (e.g., 120) that represents coherent information from the information source.

FIG. 22 illustrates a flow diagram of an example, non-limiting computer-implemented method 2200 that can facilitate coherent hyperedges for document QA in accordance with one or more embodiments described herein. In various cases, the coherent hypergraphs for natural language question answering system 102 can facilitate the computer-implemented method 2200.

In various cases, act 2202 can include determining, by the device (e.g., via 118), if there are probabilistic weights of hyperedges that are below a defined threshold of coherence. If not, the computer-implemented method 2200 can proceed to act 2204. If so, the computer-implemented method 2200 can instead proceed to act 2206.

In various aspects, act 2204 can include excluding, by the device (e.g., via 118), the hyperedges from the set of coherent hyperedges.

In various instances, act 2206 can include receiving, by the device (e.g., via 110), a natural language question (e.g., 120).

In various cases, act 2208 can include embedding, by the device (e.g., via 704), the natural language question and the set of coherent hyperedges into vectors.

In various cases, act 2210 can include performing, by the device (e.g., 118), a semantic search on the vectors of the natural language question and the set of coherent hyperedges.

In various cases, act 2212 can include selecting, by the device (e.g., 118), a subset of the set of coherent hyperedges that are relevant to the natural language question based on the semantic search.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively generate, via a foundation model, a hypergraph with coherent hyperedges that represent an information source as the one or more embodiments described herein can enable this process. And, neither can the human mind nor a human with pen and paper generate, via a foundation model, a hypergraph with coherent hyperedges that represent an information source, as conducted by one or more embodiments described herein.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

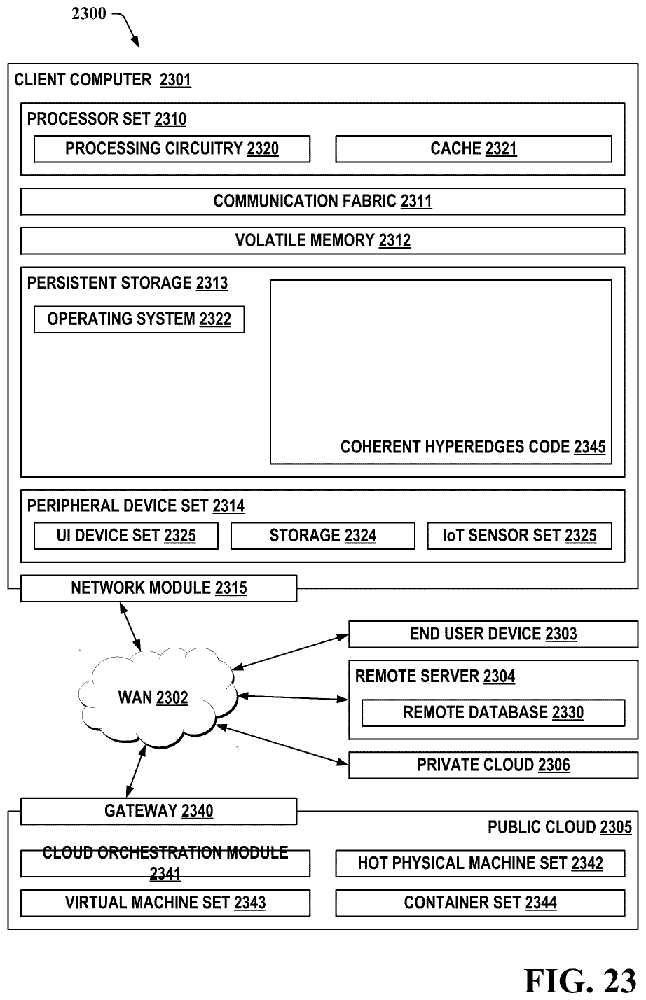

FIG. 23 illustrates a block diagram of an example, non-limiting, operating environment in which one or more embodiments described herein can be facilitated. FIG. 23 and the following discussion are intended to provide a general description of a suitable operating environment 2300 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 2300 contains an example of an environment for the execution of at least some of the computer code involved in performing the inventive methods, such as coherent hyperedges code 2326. In addition to block 2326, computing environment 2300 includes, for example, computer 2301, wide area network (WAN) 2302, end user device (EUD) 2303, remote server 2304, public cloud 2305, and private cloud 2306. In this embodiment, computer 2301 includes processor set 2310 (including processing circuitry 2320 and cache 2321), communication fabric 2311, volatile memory 2312, persistent storage 2313 (including operating system 2322 and block 2326, as identified above), peripheral device set 2314 (including user interface (UI), device set 2325, storage 2324, and Internet of Things (IoT) sensor set 2325), and network module 2315. Remote server 2304 includes remote database 2330. Public cloud 2305 includes gateway 2340, cloud orchestration module 2341, host physical machine set 2342, virtual machine set 2343, and container set 2344.

COMPUTER 2301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 2330. As is well understood in the art of computer technology, and depending upon the technology, performance of a computer-implemented method may be distributed among multiple computers and/or between multiple locations. On the other hand, in this presentation of computing environment 2300, detailed discussion is focused on a single computer, specifically computer 2301, to keep the presentation as simple as possible. Computer 2301 may be located in a cloud, even though it is not shown in a cloud in FIG. 23. On the other hand, computer 2301 is not required to be in a cloud except to any extent as may be affirmatively indicated.

PROCESSOR SET 2310 includes one, or more, computer processors of any type now known or to be developed in the future. Processing circuitry 2320 may be distributed over multiple packages, for example, multiple, coordinated integrated circuit chips. Processing circuitry 2320 may implement multiple processor threads and/or multiple processor cores. Cache 2321 is memory that is located in the processor chip package(s) and is typically used for data or code that should be available for rapid access by the threads or cores running on processor set 2310. Cache memories are typically organized into multiple levels depending upon relative proximity to the processing circuitry. Alternatively, some, or all, of the cache for the processor set may be located “off chip.” In some computing environments, processor set 2310 may be designed for working with qubits and performing quantum computing.

Computer readable program instructions are typically loaded onto computer 2301 to cause a series of operational steps to be performed by processor set 2310 of computer 2301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 2321 and the other storage media discussed below. The program instructions, and associated data, are accessed by processor set 2310 to control and direct performance of the inventive methods. In computing environment 2300, at least some of the instructions for performing the inventive methods may be stored in block 2326 in persistent storage 2313.

COMMUNICATION FABRIC 2311 is the signal conduction paths that allow the various components of computer 2301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 2312 is any type of volatile memory now known or to be developed in the future. Examples include dynamic type random access memory (RAM) or static type RAM. Typically, the volatile memory is characterized by random access, but this is not required unless affirmatively indicated. In computer 2301, the volatile memory 2312 is located in a single package and is internal to computer 2301, but, alternatively or additionally, the volatile memory may be distributed over multiple packages and/or located externally with respect to computer 2301.

PERSISTENT STORAGE 2313 is any form of non-volatile storage for computers that is now known or to be developed in the future. The non-volatility of this storage means that the stored data is maintained regardless of whether power is being supplied to computer 2301 and/or directly to persistent storage 2313. Persistent storage 2313 may be a read only memory (ROM), but typically at least a portion of the persistent storage allows writing of data, deletion of data and re-writing of data. Some familiar forms of persistent storage include magnetic disks and solid state storage devices. Operating system 2322 may take several forms, such as various known proprietary operating systems or open source Portable Operating System Interface type operating systems that employ a kernel. The code included in block 2326 typically includes at least some of the computer code involved in performing the inventive methods.

PERIPHERAL DEVICE SET 2314 includes the set of peripheral devices of computer 2301. Data communication connections between the peripheral devices and the other components of computer 2301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 2325 may include components such as a display screen, speaker, microphone, wearable devices (such as goggles and smart watches), keyboard, mouse, printer, touchpad, game controllers, and haptic devices. Storage 2324 is external storage, such as an external hard drive, or insertable storage, such as an SD card. Storage 2324 may be persistent and/or volatile. In some embodiments, storage 2324 may take the form of a quantum computing storage device for storing data in the form of qubits. In embodiments where computer 2301 is required to have a large amount of storage (for example, where computer 2301 locally stores and manages a large database) then this storage may be provided by peripheral storage devices designed for storing very large amounts of data, such as a storage area network (SAN) that is shared by multiple, geographically distributed computers. IoT sensor set 2325 is made up of sensors that can be used in Internet of Things applications. For example, one sensor may be a thermometer and another sensor may be a motion detector.

NETWORK MODULE 2315 is the collection of computer software, hardware, and firmware that allows computer 2301 to communicate with other computers through WAN 2302. Network module 2315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 2315 are performed on the same physical hardware device. In other embodiments (for example, embodiments that utilize software-defined networking (SDN)), the control functions and the forwarding functions of network module 2315 are performed on physically separate devices, such that the control functions manage several different network hardware devices. Computer readable program instructions for performing the inventive methods can typically be downloaded to computer 2301 from an external computer or external storage device through a network adapter card or network interface included in network module 2315.

WAN 2302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 2303 is any computer system that is used and controlled by an end user (for example, a customer of an enterprise that operates computer 2301), and may take any of the forms discussed above in connection with computer 2301. EUD 2303 typically receives helpful and useful data from the operations of computer 2301. For example, in a hypothetical case where computer 2301 is designed to provide a recommendation to an end user, this recommendation would typically be communicated from network module 2315 of computer 2301 through WAN 2302 to EUD 2303. In this way, EUD 2303 can display, or otherwise present, the recommendation to an end user. In some embodiments, EUD 2303 may be a client device, such as thin client, heavy client, mainframe computer, desktop computer and so on.

REMOTE SERVER 2304 is any computer system that serves at least some data and/or functionality to computer 2301. Remote server 2304 may be controlled and used by the same entity that operates computer 2301. Remote server 2304 represents the machine(s) that collect and store helpful and useful data for use by other computers, such as computer 2301. For example, in a hypothetical case where computer 2301 is designed and programmed to provide a recommendation based on historical data, then this historical data may be provided to computer 2301 from remote database 2330 of remote server 2304.

PUBLIC CLOUD 2305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 2305 is performed by the computer hardware and/or software of cloud orchestration module 2341. The computing resources provided by public cloud 2305 are typically implemented by virtual computing environments that run on various computers making up the computers of host physical machine set 2342, which is the universe of physical computers in and/or available to public cloud 2305. The virtual computing environments (VCEs) typically take the form of virtual machines from virtual machine set 2343 and/or containers from container set 2344. It is understood that these VCEs may be stored as images and may be transferred among and between the various physical machine hosts, either as images or after instantiation of the VCE. Cloud orchestration module 2341 manages the transfer and storage of images, deploys new instantiations of VCEs and manages active instantiations of VCE deployments. Gateway 2340 is the collection of computer software, hardware, and firmware that allows public cloud 2305 to communicate through WAN 2302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 2306 is similar to public cloud 2305, except that the computing resources are only available for use by a single enterprise. While private cloud 2306 is depicted as being in communication with WAN 2302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 2305 and private cloud 2306 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be cither volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes at least one of the computer executable components that:
generates, via a foundation model, a hypergraph comprising nodes and hyperedges, wherein the nodes represent entities in an information source, wherein the hyperedges represent relationships between two or more of the nodes, and wherein the hyperedges are associated with respective probabilistic weights; and
selects, from the hyperedges, a set of coherent hyperedges for a natural language question that represents coherent information from the information source.

2. The system of claim 1, wherein generating the hypergraph comprises:
extracting the entities from the information source;
generating a knowledge graph comprising the nodes and edges, wherein the nodes represent the entities, wherein the edges are pair-wise relationships between the nodes, and wherein the edges are associated with respective probabilistic weights; and
generating, based on the respective probabilistic weights of the edges, the hypergraph using the knowledge graph.

3. The system of claim 1, wherein at least one of the computer executable components further:
embeds, via a text-embedding model, the hyperedges and the natural language question.

4. The system of claim 1, wherein at least one of the computer executable components further:
selects, using semantic search, the set of coherent hyperedges based on a similarity between the natural language question and the hyperedges.

5. The system of claim 1, wherein at least one of the computer executable components further:
inputs the natural language question and the set of coherent hyperedges into a generative large language model to generate a natural language response.

6. The system of claim 1, wherein the probabilistic weights associated with the hyperedges are a function of proximity between at least one of: location of the entities, length of information source, or thematic entity category.

7. The system of claim 1, wherein the probabilistic weights associated with the hyperedges quantify a probability of coherently linking two or more of the nodes with a hyperedge.

8. The system of claim 2, wherein the probabilistic weights associated with the edges quantify a probability of nodes being coherently related.

9. The system of claim 2, wherein the entities comprise entities extracted from the information source using natural language processing or user-identified entities.

10. The system of claim 1, wherein the hyperedges are stored in a database, and wherein selecting the set of coherent hyperedges comprises:
retrieving the set of coherent hyperedges from the database in response to receiving the natural language question.

11. The system of claim 1, wherein training the foundation model comprises:
pre-training the foundation model on a first training dataset to generate natural language, wherein the first training dataset comprises a plurality of textual data; and
training the foundation model on a second training dataset to generate the hypergraph, wherein the second training dataset comprises textual data and corresponding hypergraphs.

12. A computer-implemented method, comprising:
generating, by a system operatively coupled to a processor and via a foundation model, a hypergraph comprising nodes and hyperedges, wherein the nodes represent the entities, wherein the hyperedges represent relationships between two or more of the nodes, and wherein the hyperedges are associated with respective probabilistic weights; and
selecting, by the system and from the hyperedges, a set of coherent hyperedges for a natural language question that represents coherent information from the information source.

13. The computer-implemented method of claim 12, wherein generating the hypergraph comprises:
extracting the entities from the information source;
generating a knowledge graph comprising the nodes and edges, wherein the nodes represent entities, wherein the edges are pair-wise relationships between the nodes, and wherein the edges are associated with respective probabilistic weights; and
generating, based on the respective probabilistic weights of the edges, the hypergraph using the knowledge graph.

14. The computer-implemented method of claim 12, further comprising:
selecting, by the system and using semantic search, the set of coherent hyperedges based on a similarity between the natural language question and the hyperedges.

15. The computer-implemented method of claim 12, further comprising:
inputting, by the system, the natural language question and the set of coherent hyperedges into a generative large language model to generate a natural language response.

16. The computer-implemented method of claim 12, wherein the probabilistic weights associated with the hyperedges are a function of proximity between at least one of: location of the entities, length of information source, or thematic entity category.

17. The computer-implemented method of claim 12, wherein the probabilistic weights associated with the hyperedges quantifies a probability of coherently linking more than one of the nodes with a hyperedge.

18. The computer-implemented method of claim 12, wherein training the foundation model comprises:
pre-training the foundation model on a first training dataset to generate natural language, wherein the first training dataset comprises a plurality of textual data; and
training the foundation model on a second training dataset to generate the hypergraph, wherein the second training dataset comprises textual data and corresponding hypergraphs.

19. A computer program product for extracting coherent information from an information source, the computer program product comprising a computer readable storage medium having program instructions embodied therewith, the program instructions executable by a processor to cause the processor to:
generate, by the processor and via a foundation model, a hypergraph comprising nodes and hyperedges, wherein the nodes represent the entities, wherein the hyperedges represent relationships between two or more of the nodes, and wherein the hyperedges are associated with respective probabilistic weights; and
select, by the processor and from the hyperedges, a set of coherent hyperedges for a natural language question that represents coherent information from the information source.

20. The computer program product of claim 19, wherein training the foundation model comprises:
pre-training the foundation model on a first training dataset to generate natural language, wherein the first training dataset comprises a plurality of textual data; and
training the foundation model on a second training dataset to generate the hypergraph, wherein the second training dataset comprises textual data and corresponding hypergraphs.
